(19) United States
(12) Patent Application Publication
(10) Pub. No.: US 2023/0082445 A1
(43) Pub. Date: Mar. 16, 2023

(54) Eco-Friendly, Crack-Resistant Cementitious Materials

(71) Applicant: TEXAS A&M UNVERSITY, College Station, TX (US)

(72) Inventors: Zachary C. Grasley, College Station, TX (US); Xijun Shi, College Station, TX (US); Anol K. Mukhopadhyay, College Station, TX (US)

(73) Assignee: Texas A&M University, College Station, TX (US)

(21) Appl. No.: 17/782,960

(22) PCT Filed: Dec. 4, 2020
(86) PCT No.: PCT/US2020/063295

§ 371 Date: Jun. 6, 2022

Related U.S. Application Data
(60) Provisional application No. 62/943,488, filed on Dec. 4, 2019.

(51) Int. Cl. C04B 18/16; C04B 28/02; C04B 18/04; C04B 14/38; C04B 14/48; C04B 40/00; C04B 14/06; C04B 18/08

(52) U.S. Cl. CPC C04B 18/167; C04B 28/02; C04B 18/0418; C04B 14/386; C04B 14/48; C04B 40/0046; C04B 14/06; C04B 18/08; C04B 2111/343

(57) ABSTRACT

Provided herein are cementitious materials, for example, a crack-resistant cementitious mortar. The cementitious materials are a mixture of cement, at least one recycled fiber reinforcement material, a recycled aggregate material, and water. Also provided is a method for increasing the crack-resistance of a cementitious material by replacing the sand in a cement mortar with a recycled aggregate material and adding at least one recycled fiber reinforcement material and a volume of water.

### CROSS-REFERENCE TO RELATED APPLICATIONS

This international application claims benefit of priority under 35 U.S.C. § 119(e) of provisional application U.S. Ser. No 62/943,488, filed Dec. 4, 2019, the entirety of which is hereby incorporated by reference.

### BACKGROUND OF THE INVENTION

### Field of the Invention

The present invention relates generally to the fields of materials science, particularly composite materials, and recycling. Specifically, the present invention relates to cementitious materials containing one or more recycled materials.

### Description of the Related Art

Waste management is one of the principal challenges faced by many countries. The U.S Interstate Highway System was established between the 1950s and 1990s, and most of the U.S pavements have already exceeded their design life and need some maintenance and rehabilitation. The increased maintenance has generated an enormous amount of pavement “waste” which awaits to be disposed of in an economical and environmentally friendly way ( ).

Reclaimed asphalt pavement (RAP) is a recycled material generated when asphalt pavements are removed for reconstruction, resurfacing, or to obtain access to buried utilities (2). Reclaimed asphalt pavement has been predominantly used in new hot mix asphalt (HMA) for pavement applications, but the reclaimed asphalt pavement replacement level in a new mixture is usually limited to 20% in the surface layer of asphalt pavement because too much reclaimed asphalt pavement incorporation can lead to serious cracking problems (3).

There is a growing interest in using reclaimed asphalt pavement as an aggregate replacement in portland cement concrete (PCC). Researchers came out in favor of incorporating coarse reclaimed asphalt pavement (size fractions larger than 2.36 or 4.75 mm depending on definition) to replace up to 50% coarse virgin aggregate in PCC paving mix (4-10), but the interest on researching and implementing PCC containing fine reclaimed asphalt pavement (size fractions smaller than 2.36 or 4.75 mm depending on definition) for pavement applications is generally limited. Several research groups in the past found that the addition of fine reclaimed asphalt pavement reduces cementitious materials' workability, compressive strength, Young's modulus, flexural strength, and splitting tensile strength to a greater extent compared to coarse reclaimed asphalt pavement (11-18). Modarres and Hosseini (15) also found that PCC containing fine reclaimed asphalt pavement exhibited lower fatigue resistance compared to PCC containing coarse reclaimed asphalt pavement.

In contrast to the detrimental effect of reclaimed asphalt pavement addition on certain concrete properties, cementitious materials' ductility and toughness are greatly improved when asphalt is incorporated (19-22). Researchers noticed that RAP-PCC exhibits better fracture properties such as critical stress intensity factor and critical crack opening displacement (4, 22). Because fine reclaimed asphalt pavement typically has higher asphalt content than coarse reclaimed asphalt pavement, the ductility, toughness, and fracture properties improvements of the cementitious materials containing fine reclaimed asphalt pavement could be even more significant. Additionally, cementitious materials containing fine reclaimed asphalt pavement are anticipated to have much better crack resistance due to their reduced Young's modulus and increased stress dissipation, but this aspect has not been widely demonstrated. The only relevant results are those of Topcu and Isikdag (46) who found the addition of fine reclaimed asphalt pavement to concrete yielded lower crack width and delayed cracking time relative to the control concrete specimens.

Correspondingly, around 4.2 million tons of scrap tires were generated in 2017 in the US (22). While half of all annually generated scrap tires have been used as tire derived fuel, some states are statutorily prohibited from promoting fuel-related uses for tires and tire-related materials due to the increasing environmental concern (22). A more sustainable way to recycle scrap tire waste is to use it in construction materials (23-24). One major byproduct of recycled tires is ground rubber, which has already been successfully used in both asphalt concrete and cement concrete for building quieter and more durable roads. During the production of ground rubber from scrap tires, steel fibers with irregular shapes and varying dimensions are extracted. The amount of the recycled steel fibers extracted from scrap tires can account for 15% of the total weight of the tire waste. Unfortunately, the recycled steel fibers has conventionally been treated as ready-to-melt steel, which is a less economical and environmentally friendly application in comparison to direct reuse. Unsorted recycled steel fibers from scrap tires can be approximately 10 times cheaper than industry-made steel fiber (25). Furthermore, life cycle assessment studies have demonstrated that processing the recycled steel fibers consumes less energy compared to typical manufactured steel fibers (MSFs) (26). With the rapid development of the tire recycling industry, waste tire processors in the US have employed better processing technology to extract recycled steel fibers with good quality, e.g., little rubber residue adhered to fiber surfaces. The technical enhancement along with a growing level of awareness of sustainability warrants the potential utilization of recycled steel fibers to reinforce cementitious materials.

Thus, there is a recognized need for improved, eco-friendly cementitious materials suitable for building construction. Specifically, the prior art is deficient in crack-resistant cementitious materials formulated with aggregates and reinforcement materials made of recycled materials. The present invention fulfills this longstanding need and desire in the art.

### SUMMARY OF THE INVENTION

The present invention is directed to cementitious material. The cementitious material comprises a cement; a first recycled fiber reinforcement material; a recycled aggregate material; and water. The present invention is directed to a related cementitious material further comprising a second recycled fiber reinforcement material. The present invention is directed to another related cementitious material further comprising a virgin aggregate material. The present invention is directed to yet another related cementitious material further comprising a coarse aggregate material.

The present invention also is directed to a crack-resistant cement concrete. The crack-resistant cemet concrete comprises a cement, at least one recycled fiber reinforcement material, a recycled aggregate material, a coarse aggregate, and water. The present invention is directed to a related crack-resistant cement concrete further comprising a virgin aggregate material.

The present invention is directed further to a crack-resistant cementitious mortar. The crack-resistant cementitious mortar comprises a mixture in water of a cement and of a recycled steel fiber and an aggregate of a reclaimed asphalt pavement. The present invention is directed to a related crack-resistant cementitious mortar further comprising recycled carbon fiber. The present invention is directed to another related crack-resistant cementitious mortar further comprising a virgin aggregate material.

The present invention is directed further to a method for increasing the crack-resistance of a cementitious material. In the method sand in a cement mortar is replaced with a recycled aggregate material. A first recycled fiber reinforcement material is added to the cement mortar and a volume of water is added. The present invention is directed to a related method further comprising adding a second recycled fiber reinforcement material to the cement mortar and adjusting the volume of water. The present invention is directed to another related method further comprising adding a virgin aggregate material to the cement mortar and adjusting the volume of water. The present invention is directed to yet another related method where the cementitious material is a cement concrete and where the method further comprises adding a coarse aggregate and adjusting the volume of water.

Other and further aspects, features, benefits, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1B compares the sieve size of Fine RAP with Concrete sand (FIG. 1A) and shows a thin section of the Fine RAP under a transmitted light optical microscope (FIG. 1B).

FIG. 2 illustrates a normalized curve representing the normalized strain relationship for the tested material.

FIGS. 3A-3F are histograms of comparing the area (FIGS. 3A-3B), shortest diameter (FIGS. 3C-3D) and the longest diameter (FIGS. 3E-3F) of the air void for CON-mortar (FIGS. 3A, 3C, 3D) and RAP-mortar (FIGS. 3B, 3D, 3F).

FIGS. 4A-4B are microscope pictures of thin sections showing RAP particles with adhered asphalt layers in the RAP mortar (FIG. 4A) and a microcrack passing through the asphalt layer (FIG. 4B) highlighting air voids and cracks

FIGS. 5A-5B show the heat of hydration from 0-30 mins (FIG. 5A) and from 0-48 hours (FIG. 5B).

FIGS. 6A-6D compares the Young's modulus (FIG. 6A), compressive strength (FIG. 6B), splitting tensile strength (FIG. 6C), and toughness ratio (FIG. 6D) for CON-mortar and RAP-mortar.

FIG. 7 illustrates the ductility of the RAP-mortar (left) which remained attached compared to the CON-mortar (right) which fell apart into pieces after the compression test.

FIGS. 8A-8B show the length change (FIG. 8A) and mass loss (FIG. 8B) of the prism specimens over 84 days.

FIGS. 9A-9B show the results of the autogenous shrinkage test of the prism specimens over 84 days

FIG. 10 compares the restrained drying shrinkage results from the ring test of four CON-mortar and four RAP-mortar samples.

FIGS. 11A-11C illustrate recycled steel fiber dimensions of diameter (FIG. 11A), length (FIG. 11B) and aspect ratio (FIG. 11C).

FIG. 12 shows a typical load vs CMOD curves for the cement mortars at selected ages.

FIG. 13 shows a typical effective crack length development with the increase of CMOD for the cement mortars at different ages.

FIG. 14 shows the critical stress intensity factors for the cement mortars at different ages

FIG. 15 shows the critical crack tip opening displacement for the cement mortars at different ages

FIG. 16 shows the initial fracture energy for the cement mortars at different ages.

FIG. 17 shows the total fracture energy for the cement mortars at different ages.

FIG. 18 shows the residual stress intensity factors associated with the full CMOD range for the 2% RSFRM.

FIG. 19 shows the theoretical tensile strength for the studied cement mortars at different ages.

### DETAILED DESCRIPTION OF THE PRESENT INVENTION

The articles “a” and “an” when used in conjunction with the term “comprising” in the claims and/or the specification, may refer to “one”, but is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “of” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the terms “about” refers to a numeric value, including, for example, whole numbers, fractions, and percentages, whether or not explicitly indicated. The term “about” generally refers to a range of numerical values (e.g., +/−5-10% of the recited value) that one of ordinary skill in the art would consider equivalent to the recited value (e.g., having the same function or result). In some instances, the term “about” may include numerical values that are rounded to the nearest significant figure. For example, the term “about 20%” when referring to the volume percent of the cement in the cementitious materials or crack-resistant cementitious mortars provided herein encompasses 18% to 22%.

As used herein, the term “cementitious material” as provided herein includes or is interchangeable with “crack-resistant cementitious material”, “crack-resistant cement concrete” and with “crack-resistant cementitious mortar.

In one embodiment of the present invention, there is provided a cementitious material, comprising a cement; a first recycled fiber reinforcement material; a recycled aggregate material; and water. Further to this embodiment the cementitious material comprises a second recycled fiber reinforcement material. In this further embodiment the second recycled fiber reinforcement material may be recycled carbon fiber. In another further embodiment the cementitious material comprises a virgin aggregate material. In another further embodiment the cementitious material comprises a coarse aggregate material.

In all embodiments, the first recycled fiber reinforcement material may be recycled steel fiber from scrap tires. Also, the recycled aggregate material may be reclaimed asphalt pavement. In addition, the cementitious material may have both an increased ductility and an increased crack resistance without loss to impact toughness, splitting tensile strength and compressive strength. Furthermore, the cement may comprise about 20% by volume thereof.

In another embodiment of the present invention, there is provided a crack-resistant cement concrete, comprising a cement; at least one recycled fiber reinforcement material; a recycled aggregate material; a coarse aggregate; and water. Further to this embodiment the crack-resistant cement concrete may comprise a virgin aggregate material.

In one aspect of both embodiments the at least one recycled fiber reinforcement material may be a recycled steel fiber. In another aspect of both embodiments the at least one recycled fiber reinforcement material may comprise a recycled steel fiber and a carbon steel fiber. In both embodiments the recycled aggregate material may be reclaimed asphalt pavement. Also in both embodiments the cement may comprise about 20% by volume thereof. In addition both crack resistance and ductility are increased without loss to impact toughness, splitting tensile strength, and compressive strength.

In yet another embodiment of the present invention, there is provided a crack-resistant cementitious mortar, comprising a mixture in water of a cement and of a recycled steel fiber and an aggregate of a reclaimed asphalt pavement. Further to this embodiment the crack-resistant cementitious mortar may comprise recycled carbon fiber in the mixture. In another further embodiment the crack-resistant cementitious mortar comprises a virgin aggregate material in the mixture.

In all embodiments the reclaimed asphalt pavement may be fine reclaimed asphalt pavement. Also in all embodiments, the cement may comprise about 20% by volume of the crack-resistant cementitious mortar. In addition, both crack resistance and ductility may be increased without loss to impact toughness, splitting tensile strength, and compressive strength.

In yet another embodiment of the present invention, there is provided a method for increasing the crack-resistance of a cementitious material, comprising replacing sand in a cement mortar with a recycled aggregate material; adding a first recycled fiber reinforcement material; and adding a volume of. Further to this embodiment the method may comprise adding a second recycled fiber reinforcement material to the cement mortar; and adjusting the volume of water. In this further embodiment the second recycled fiber reinforcement material is recycled carbon fiber. In another further embodiment, the method comprises adding a virgin aggregate material to the cement mortar and adjusting the volume of water. In yet another further embodiment the crack-resistant cementitious material is a cement concrete and the method further comprises adding a coarse aggregate; and adjusting the volume of water. In all embodiments, the first recycled fiber reinforcement material may be recycled steel fiber. Also in all embodiments, the cement may comprise about 20% by volume of the cementitious material.

Provided herein are cementitious materials and cementitious mortars that are a mixture of cement, recycled materials as replacements for conventional aggregates and fiber reinforcement materials. These materials comprise recycled steel fiber from scrap tire as a first fiber reinforcement material, reclaimed asphalt pavement (RAP) as an aggregate replacement, and, optionally, recycled carbon fiber as a second or additional fiber reinforcement material. Moreover, in addition to the recycled aggregate material, the cementitious materials may further comprise a virgin aggregate excluding sand.

The cementitious materials or cementitious mortars are very economically and environmentally friendly as more than 70% by volume of these materials is made of recycled materials. The cementitious materials and mortars have a much increased cracking resistance compared to plain cementitious materials, due to the low elastic modulus and the high creep compliance of the RAP and the fiber bridging effect. They also have a greater energy absoprtion capacity than plain cementitious materials. The asphalt coating on the RAP acts as a lubricant and compensates the workability loss caused by the recycled fiber addition. The recycled fibers compensate for the reduced tensile strength caused by the RAP addition. The crack-resistant cementitious materials provided herein need no or a limited amount of a water reducer or superplasticizer because of improved workability by the RAP.

The crack-resistant cementitious materials and crack-resistant cementitious mortars provided herein have a wide application in constructing and repairing concrete structures whose anti-cracking performance is crucial, for example, but not limited to, critical structures under harsh environments, such as a very dry environment. The crack-resistant cementitious materials and crack-resistant cementitious mortars are also ideal materials for highway barriers because of their superior cracking resistance and energy absorption capacity. Moreover, the cementitious materials and mortars have applications as a 3D printing material. The density of the crack-resistant cementitious material is lower than that of normal concrete, which helps reduce structure self-weight.

The following examples are given for the purpose of illustrating various embodiments of the invention and are not meant to limit the present invention in any fashion.

### EXAMPLE 1

### Materials and Mix Design: Reclaimed Asphalt Pavement (RAP)

### Microstructural Features

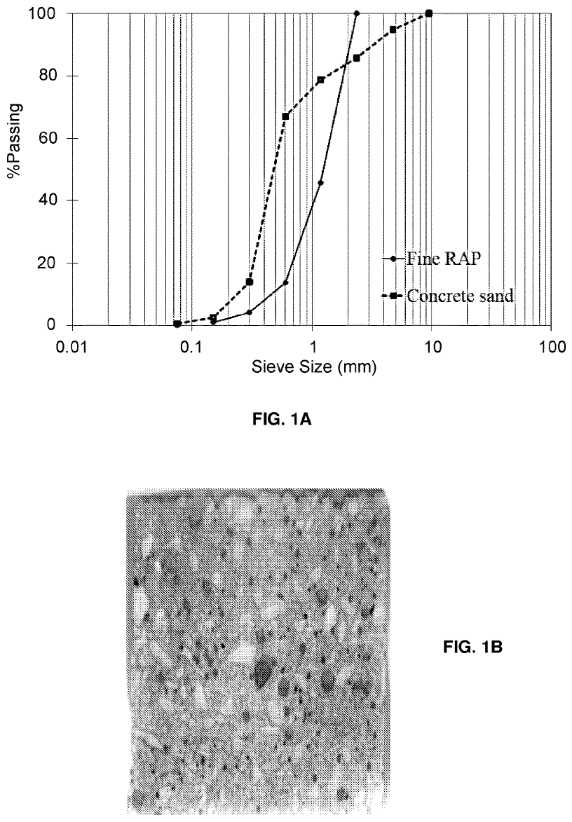

Two mortar mixtures with a 0.40 water to cementitious material ratio were designed and produced: one was a control cement mortar mixture containing regular concrete sand (i.e., the CON-mortar) and the other was a cement mortar mixture with fine RAP to replace 100% of the sand on a volumetric basis (i.e., the RAP-mortar). The decision to replace sand by an equivalent volume of fine RAP was made because most of the current concrete mixture designs use volumetric procedures to proportion mixtures (27). A locally available Type I/II cement was used, and a class F fly ash collected from a fly ash producer in Jewett, Texas served as a supplementary cementing material to replace 20% of the cement (by weight). The fine RAP was produced by screening out the coarse portion of a RAP material collected from Bryan, Texas with a 2.36-mm sieve. The gradations of the virgin concrete sand and fine RAP are compared in FIG. 1A. It is shown that the fine RAP is coarser than the concrete sand, which is due to the asphalt layer adhered to the RAP particles and the potential for multiple particles bonding together with the asphalt binder (28). Other material properties of the sand and the fine RAP are listed in Table 1.

TABLE 1
Aggregate material characterization

| | | Oven dry | | Asphalt |
|---|---|---|---|---|
| | Stone | specific | Absorption | content |
| Materials | type | gravity | (%) | (%) |
| Concrete | Siliceous | 2.58 | 2.06 | NA |
| sand | river sand | | | |
| Fine RAP | Limestone | 2.07 | 6.87 | 8.96 |

NA is not applicable

As expected, the fine RAP has a lower specific gravity compared to the sand because of the low density of asphalt. The water absorption of the fine RAP is much higher relative to the sand, and this finding matches well with that from those from the previous investigations (29-32). The high-water absorption of fine RAP may offer benefits resulting from internal curing if the fine RAP is pre-wetted. The asphalt content of the fine RAP was determined as 8.96% by mass using the ignition method specified in ASTM D6307; this value is significantly higher than the values for typical coarse RAP aggregates used in the previous studies (6, 31, 33), presumably due to the significantly higher surface area to volume ratio of finer versus coarser particles.

The mix proportions of the studied mortar mixtures are shown in Table 2.

TABLE 2
Saturated surface dried (SSD) mixture designs for the mortars

| Materials | | |
|---|---|---|
| (kg/m3) | CON-mortar | RAP-mortar |
| Cement | 467 | 467 |
| Fly Ash | 117 | 117 |
| Concrete sand | 1458 | 0 |
| Fine RAP | 0 | 1168 |
| Water | 234 | 234 |

Following the mix design, CON-mortar and RAP-mortar specimens for different testing purposes were fabricated. It was found that the designed RAP-mortar mixture may be mixed and cast without any problems. No significant difference in terms of workability, bleeding, or segregation between the CON-mortar and RAP-mortar was observed during the sample mixing and casting process.

### Microstructural Properties and Heat of Hydration Testing

The microstructural features of the CON-mortar and RAP-mortar were revealed via the thin section petrographic technique using a transmitted light optical microscope (FIG. 1B). Compared to typical scanning electron microscope (SEM) samples, thin section specimens have a larger sample size (75×50 mm for thin section verse 15-20×15-20 mm for SEM). Because of the larger field of view, the thin section observation is able to provide a better insight on the overall (spatially averaged) microstructural features of the specimens; the technique also enables researchers to effectively study larger pore distribution and aggregate distribution in the hardened concrete using statistical analyses. The thin section specimens used in this study were made by a company located in Houston, Texas from the hardened cement mortar samples at an age of 28 days. A blue dye was used during the thin section preparation to highlight pores and cracks in cement paste matrix and aggregate particles, and interfacial transition zone.

A micro-calorimeter was used to perform the cement heat of hydration study to assess the effect of fine RAP on cement hydration. The heat of hydration test was conducted by strictly following the steps below to ensure all the specimens were tested in the same manner.

Set the micro-calorimeter chamber temperature at 20° C. and wait for the temperature to equilibrate. Batch the thy ingredients necessary for fabricating a 20-cm³ mortar sample. Prepare the correct amount of water and add the water into the dry mixture. The amount of water was calculated by adjusting the water needed between the current moisture condition and the SSD condition of the sand. Mix the ingredients with a standard wood stir bar for 2 minutes Immediately transfer the mortar mixture to a small glass jar and measure the sample weight. t exactly 5 minutes after the initiation of mixing then put the glass jar in the micro-calorimeter and start to record the data immediately.

### Mechanical Properties Testing

The compressive strength, Young's modulus, and splitting tensile strength of the studied mixtures were tested according to ASTM C39, ASTM C469, and ASTM C496, respectively. The tests were conducted using 75×150 mm cylinder specimens, and three replicate specimens were prepared for each mix and test type. The specimens were demolded after 24 hours and then cured in a 20° C. and 100% relative humidity (RH) moist room. An MTS machine with a 1000-kN load capacity was used to test the specimen at varying curing ages (i.e., 3-day, 7-day, and 28-day). Two MTS extensometers with a 100-mm gauge length were used to record the displacement of the specimens during the Young's modulus test.

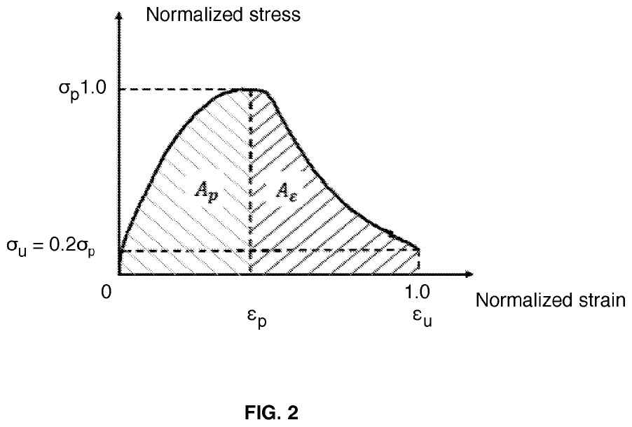

The recorded load cell versus displacement data from the splitting tension test was used to calculate a toughness ratio parameter to infer the post-cracking behavior of the mixtures. The determination of the toughness ratio (TR) follows a similar procedure in Huang et al. (20). The load against displacement curves are normalized by the peak load and the displacement corresponding to the peak load, respectively; the normalized curves represent the normalized stress and strain relationship for the tested material (FIG. 2). The TR is then defined as

$$TR = \frac{{A}_{p}}{{A}_{ε}} \qquad Eq . 1$$

where TR is the toughness ratio, Aₚ is the area under the normalized stress-strain curve up to strain εₚ, εₚ is the normalized strain corresponding to the normalized peak stress, A_{ε} is the area under the normalized stress-strain curve between the strain εₚ and strain εᵤ, and εᵤ is the ultimate strain, which is the strain value corresponding to the residual stress equal to 20% of the peak stress.

### Shrinkage Properties Testing

Prism specimens were made to measure the drying shrinkage and autogenous shrinkage for the CON-mortar and RAP-mortar. The procedures were largely based on ASTM C596. For the drying shrinkage measurement, the prism specimens were sealed using adhesive backed aluminum foil at both ends to simulate a two-dimensional drying condition. For the autogenous shrinkage test, all the specimen's surfaces were sealed. All the sealed surfaces were wrapped four times because it was found that less than four layers of aluminum foil coverage could not effectively prevent moisture from transferring from the specimen to the environment. Three replicate specimens were used for both the drying shrinkage and autogenous shrinkage tests. The specimens were fabricated and cast into the standard molds with the dimension of 25×25×285 mm. After 24 hours, the specimens were demolded, sealed as described, and immediately put into an environmental chamber with a constant temperature of 20±2° C. and a constant RH of 50±4%. The length changes and mass loss of the specimens were recorded after 3, 7, 14, 21, 28, 56, and 84 days.

The foremost property of the studied mixtures that is explored is the cracking resistance of the cement mortars under restrained drying shrinkage. There exist two types of restrained drying shrinkage tests for cementitious materials, uniaxial tests and ring tests. The ring tests were selected. The ring test is specified in ASTM C1581, although there is much criticism that the dimensions specified in ASTM C1581 do not induce concrete specimens to crack within a reasonable time period. To shorten the cracking time, a new ring geometry with a higher level of restraint was developed (34) and used herein. The new ring geometry ensures typical cement mortar mixtures show cracking within several days under a 50% RH drying condition.

In the ring test, the cement mortar was mixed and cast into the ring mold which has an inner steel ring and a removable outer ring. After the cement mortar mixture was cured in the environmental chamber under 20° C. and 100% RH for 24 hours, the outer ring mold was carefully removed, and the top face of the ring was sealed with aluminum foil to prevent drying. The RH of the chamber was then changed to 50% (the temperature remained same) so that the outer radial face of the mortar was exposed to a dry environment to induce shrinkage. During the test, a free shrinkage gradient was developed in the radial direction of the mortar specimen, but the steel ring restrained the free deformation. As a result, circumferential tensile stress was induced, and it increased with time as shrinkage increased. This increased tensile stress eventually led to radial cracks in the mortar. To infer the level of tensile stress in the mortar, circumferential strain in the steel ring was recorded using strain gages mounted to the inner radial surface of the steel. Each steel ring was equipped with four 6.2 mm/350 Ohm strain gages patterned in a full Wheatstone bridge with two Poisson gages and two linear gages. The strain was recorded at 5 min intervals using a D4 data acquisition unit. In this study, four ring tests were conducted for each mortar mixture type to ensure the results are repeatable and statistically meaningful.

### EXAMPLE 2

### Microstructure and Heat of Hydration: RAP

Microstructural observations relate to (1) the nature of air void distribution and determination of air content in the mortar specimen and (2) identification of weak zones and cracking pattern.

### Air Void Distribution

Fifteen optical microscope photos with a magnification factor of 2.5 were taken to cover the entire area of the 50×75 mm thin specimens. Using image processing software (Image J), air voids in each photo were outlined, and the area of the air voids was calculated automatically by the software. The air content for each type of mixture was then determined using the total area of the air voids divided by the total area of the field of view. Additionally, the longest diameter and the shortest diameter of each air void were measured using the same software. A comprehensive statistical analysis was subsequently performed to further assess the results.

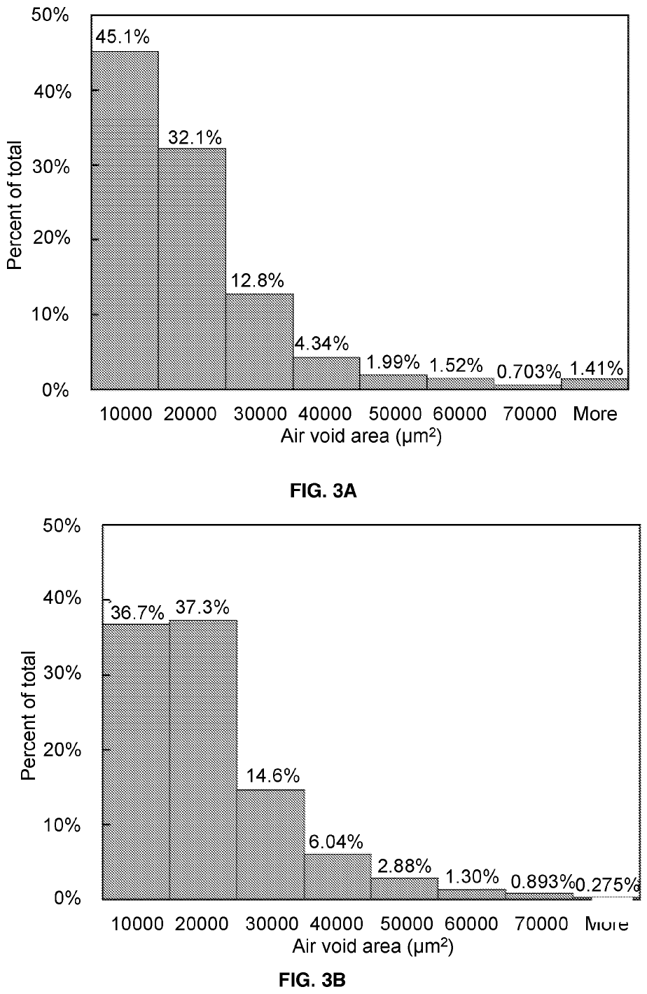

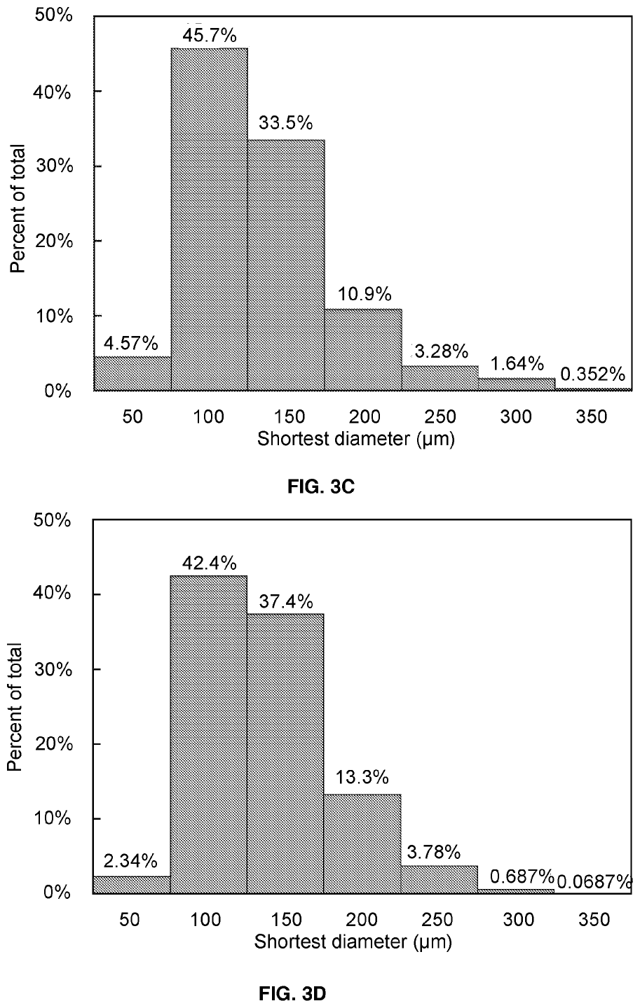

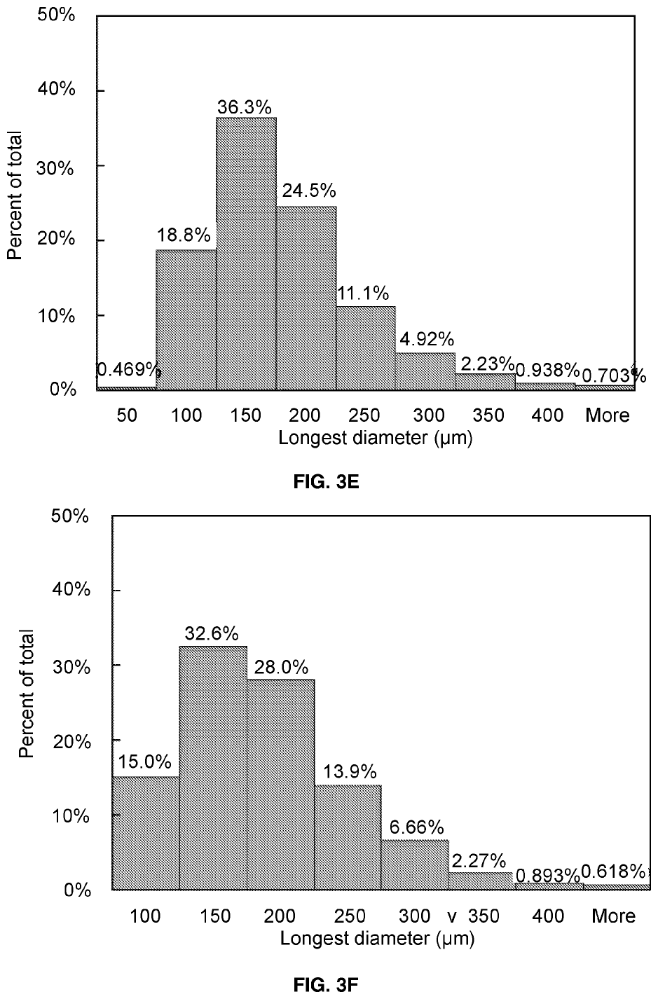

A total of 853 and 1456 air bubbles were identified and studied for the CON-mortar and the RAP-mortar, respectively; this indicates that using the fine RAP to fully replace the sand in the cement mortar yielded a much higher number of air voids. These air voids are regarded as entrapped air voids because no air entraining agent was added in the mixtures. Histograms of the area, shortest diameter, and longest diameter of the air void for the mortar mixtures with and without fine RAP (FIGS. 3A-3F). The results indicate that the air voids in the RAP-mortar are bigger than those in the CON-mortar. Because it contains a larger amount of air bubbles with bigger sizes, the total air content in the RAP-mortar is much higher. The calculated air content was 2.27% for the CON-mortar and 4.09% for the RAP-mortar. It should be noted that the high porosity of the RAP-mortar is like to create an easy path for water and ions to penetrate the matrix and subsequently causes durability issues. There are some existing investigations on durability of cementitious materials containing fine RAP (17-18), but further efforts are still highly warranted.

### Weak Zone and Crack Propagation

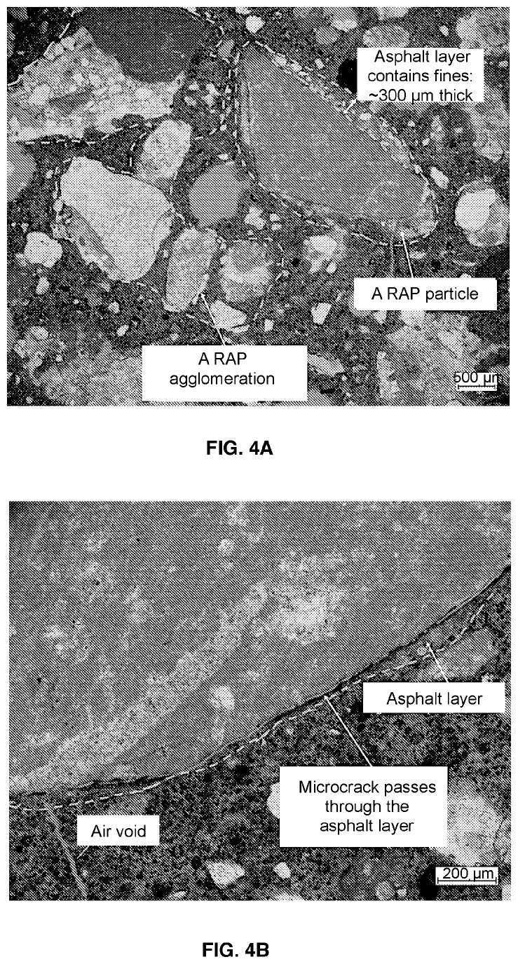

After the characterization of the air void system, additional optical microscope photos were taken to study the weak zones of the RAP-mortar. The presence of fines and voids within the asphalt layer was commonly observed. Because of the existence of small particles and voids, the thickness of the asphalt layer varied considerably. FIG. 4A shows the RAP particles in the RAP-mortar thin section specimen. The thickness of the asphalt layer for the highlighted RAP particle is around 300 um. Another observation is that the RAP particles are highly agglomerated. The formation of agglomerated RAP is caused by the adhesive asphalt binder around each RAP aggregate particle. The RAP agglomeration is a common phenomenon in RAP stockpiles, especially when the ambient temperature is high.

Since asphalt is a much weaker material in terms of mechanical strength compared to cement matrix and aggregate, the asphalt layers around the RAP particles are considered as weak zones in the cementitious materials containing RAP. The agglomerated particles usually have higher local asphalt content, so they are weak points in the RAP-mortar. Additionally, the RAP agglomeration alters the stress distribution and causes stress concentrations, which facilitates cracking initiation and propagation. The higher number of air voids and larger air void sizes (in the previous section) also make the RAP-mortar weaker than the CON-mortar. FIG. 4B shows an example of the developed microcracks passing through the asphalt layer in the RAP-mortar. The nature of crack propagation in the cementitious materials containing fine RAP has been studied by the authors' previous work using X-ray CT as well (6, 21, 28).

### Heat of Hydration

The heat evolution of cement during hydration can be divided into four stages. Stage 1 features a period of rapid evolution of heat, which is associated with the dissolution of irons. Stage 2 is a period of relative inactivity, during which little heat is generated. In Stage 3 (the rapid reaction period), a large amount of heat is generated primarily due to the hydration of the C₃S. The final period (Stage 4) is called the diffusion-limited reaction period. In this stage, the dissolved ions from the cement must diffuse outward and precipitate into the capillary pores that formed in Stage 3, or water must diffuse inward to reach the unreacted cement cores for further reaction to take place (35).

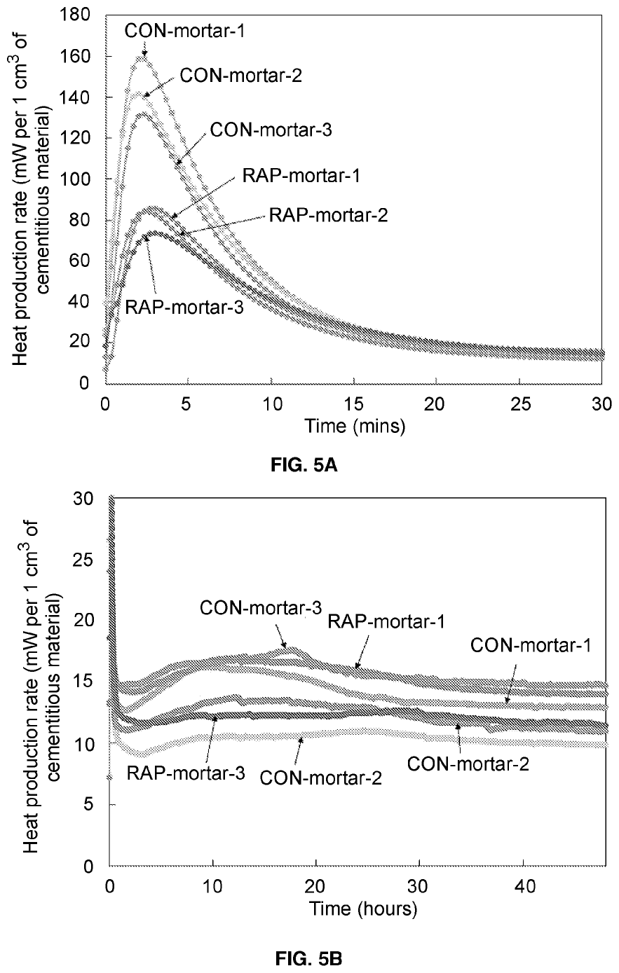

The heat of hydration measurements (i.e., calorimetric curves) of the two types of mortar samples are shown in FIGS. 5A-5B. The test ran for 3 days, but only the data up to 2 days are presented. The data for the third day has the same trend as that at the end of the second day, both indicating the Stage 4 behaviors. FIG. 5A shows a magnified view of the heat evolution within the first 30 mins of the hydration, and it indicates that all the specimens reach a peak value in the calorimetric curve within the first 5 mins This heat was given off during the dissolution of ions. Interestingly, the magnitude of the peak for the RAP-mortar is only approximately half of that for the CON-mortar. It is presumed that the heats generated during iron dissolution are equal between the RAP-mortar and CON-mortar, and the difference of the outputs is possibly attributed to the higher heat capacity of asphalt relative to sand. According to literature, the typical heat capacity of asphalt is 1900 kJ/kg·K (36), while that of aggregate is 840 kJ/kg·K (37). The higher high heat capacity of the RAP-mortar yields a smaller temperature raise given the same amount of heat generated. Since the isothermal calorimeter used in this study is a heat conduction calorimeter which utilizes the temperature difference between the sample and heat sink to calculate heat production rate, the lower temperature raise of the RAP-mortar leads to lower heat production rate in the calorimeter. It is also known that the iron dissolution is a rapid process so that the heat capacity effect cannot be neglected (38). The authors do not have additional data to further validate this explanation for the difference between initial heat generations in the calorimetric curves, and future work in this area is highly warranted.

The second peak (Stage 3) of the calorimeter curve is shown in FIG. 5B. The peak generally occurred at a time point between 5 hours and 30 hours but has a much smaller magnitude compared to the first peak for all the specimens; the magnitude of the second peak is around 10% of that of the first peak for both the CON-mortar and RAP-mortar. The second peak and the final plateau in the heat production rate curve varied among different specimens regardless of the mortar type. Because the difference for the heat production rate between the CON-mortar and RAP-mortar is indistinguishable, it is not statistically evident that the asphalt layer in the fine RAP will significantly alter cement hydration at the later stages. Also, since the rate of reaction is much lower for Stage 3, the heat capacity effect can be ignored (38). There are studies investigating the interactions between cement and asphalt emulsion (39-42). Asphalt emulsion is asphalt droplet suspended in water. The interaction mechanism between cement and asphalt emulsion droplet is mostly physical, and no additional reaction between cement and asphalt occurs (39, 42). The researchers did find that the asphalt droplet could delay cement hydration by forming a thin asphalt layer and enclosing the cement particles. However, the hydration productions of cement are able to impale the asphalt membrane, so the further hydration between cement and water is not impaired (43). In contrast to the asphalt emulsion droplet, the asphalt layer adheres to the RAP aggregate in this study, so it will not encapsulate the cement particles to prevent further cement hydration. Therefore, no significant delaying effect of RAP on cement hydration is shown in FIG. 5B either.

### EXAMPLE 3

### Mechanical Properties: RAP

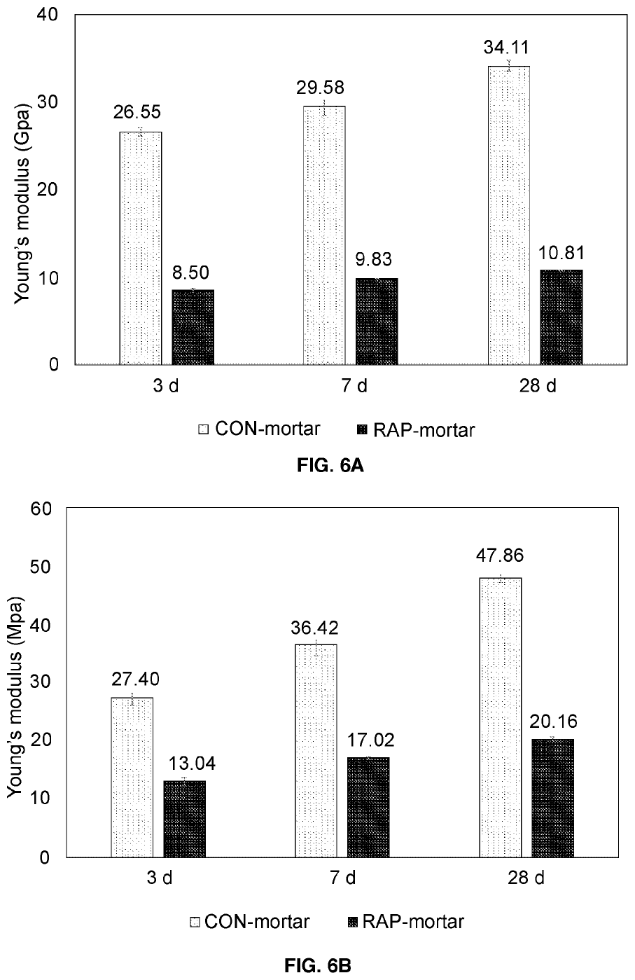

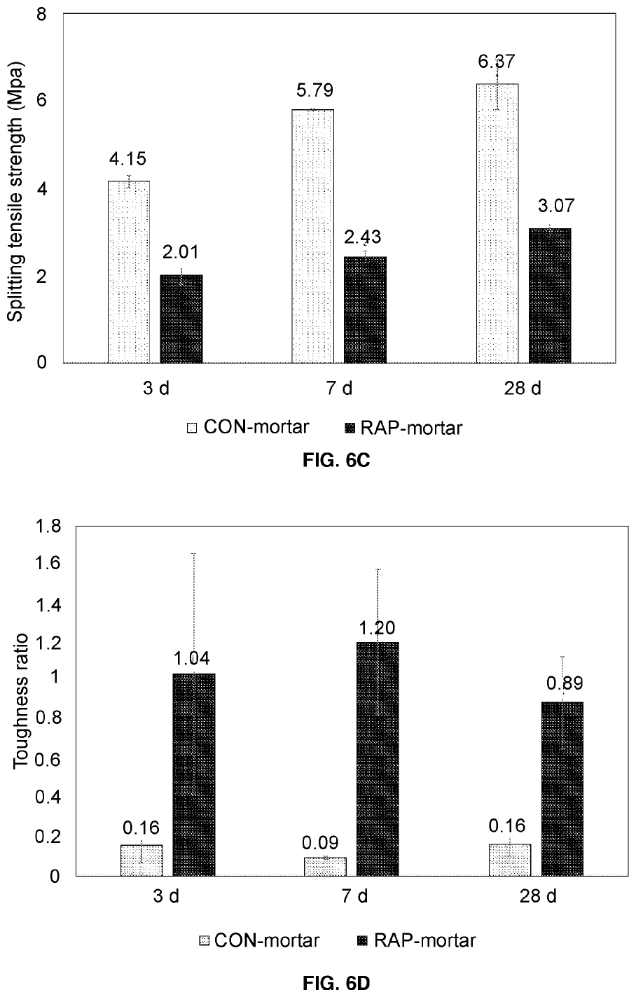

The means of Young's modulus, compressive strength, and splitting tensile strength of the CON-mortar and RAP-mortar specimens at different ages are shown in FIGS. 6A-6C, respectively. The error bars show one standard deviation from the mean. The use of fine RAP to replace virgin sand dramatically decreases the Young's modulus, compressive strength, and splitting tensile strength for cement mortar at all the ages. Compared to the control mixture, the reductions of the Young's modulus of the RAP-mortar reach 68%, 67%, and 68% at 3, 7, and 28 days, respectively. The lower modulus of the RAP-mortar is caused by the presence of asphalt; asphalt is significantly less stiff compared with the cement paste or natural sand. The RAP-mortar has a higher air content relative to the CON-mortar based on the thin section observation, and the higher air content also contributes to the lower Young's modulus of the mixture. The reductions of the RAP-mortar compressive and splitting tensile strengths relative to the control mortar are similar and invariably smaller compared to the reductions for the Young's Modulus. The percent reductions for the compressive strength are 52%, 53%, and 58% for 3, 7, and 28 days, respectively. The percent reductions for the splitting tensile strength are 51%, 58%, and 52% for 3, 7, and 28 days, respectively. Previous investigations concluded that asphalt cohesive failure and high porosity are two major reasons for the strength reduction (21, 28, 44-45), and the microstructure study in the previous section further confirmed the presence of these weak zones.

Review of the literature indicates that concrete containing coarse RAP has smaller reductions in tensile strengths (splitting tensile strength or flexural strength) compared to the reduction in the compressive strength; however, the reductions for the compressive strength and tensile strength in this study are comparable for the mortar specimens. This is likely because the primary weak zones in concrete containing coarse RAP or fine RAP differ. In concrete containing coarse RAP, the weak zone is the asphalt at the RAP and cement interface. The cement matrix in concrete containing coarse RAP might be as strong as that of the plain concrete (if the air content of the matrix is not significantly influenced, which is true for the concrete containing coarse RAP only). It is speculated that the properties of the matrix largely determine tensile strength of concrete, while the interface of coarse aggregate and matrix controls concrete's strength under compression (Birely et al. 2018). Therefore, adding coarse RAP exerts a more significant influence on the compressive strength than the tensile strengths. However, for the cement mortar, there is no interface of coarse aggregate and matrix, so both the compressive strength and tensile strength rely on the properties of the matrix. Since the fine RAP distribution in the matrix is relatively uniform and the compressive failure of matrix is essentially due to localized tensile stress, it is reasonable to find that the reductions for the compressive strength and tensile strength are similar for the RAP-mortar. FIGS. 6A-6D also reveal that both the CON-mortar and RAP-mortar experienced modulus and strength evolution with age. In general, the CON-mortar had slightly higher evolutions in terms of percentage (property evolution between a later age and the 3-day normalized by the 3-day property) for all the mechanical properties.

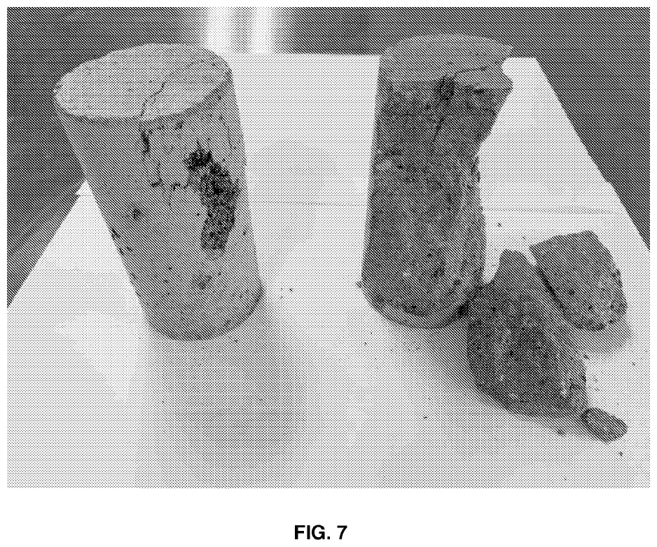

The toughness ratio of the two mortar mixtures is shown in FIG. 6D. The RAP-mortar has considerably higher toughness ratio values relative to the CON-mortar. The percent increases in the toughness ratio for the RAP-mortar relative to the CON-mortar are 563%, 1182%, and 481% for 3, 7, and 28 days, respectively. This implies that RAP-mortar is a much tougher material and could continue to absorb energy even after the occurrence of major cracks. It is also noted that the control specimens suffered explosive failures and always fell apart into several pieces, while the RAP-mortar specimens generally broke silently during the test and remained intact after the compressive strength test (FIG. 7). This phenomenon indicates the ductile nature of RAP-mortar.

### EXAMPLE 4

### Shrinkage Properties and Crack Potential: RAP

Free shrinkage

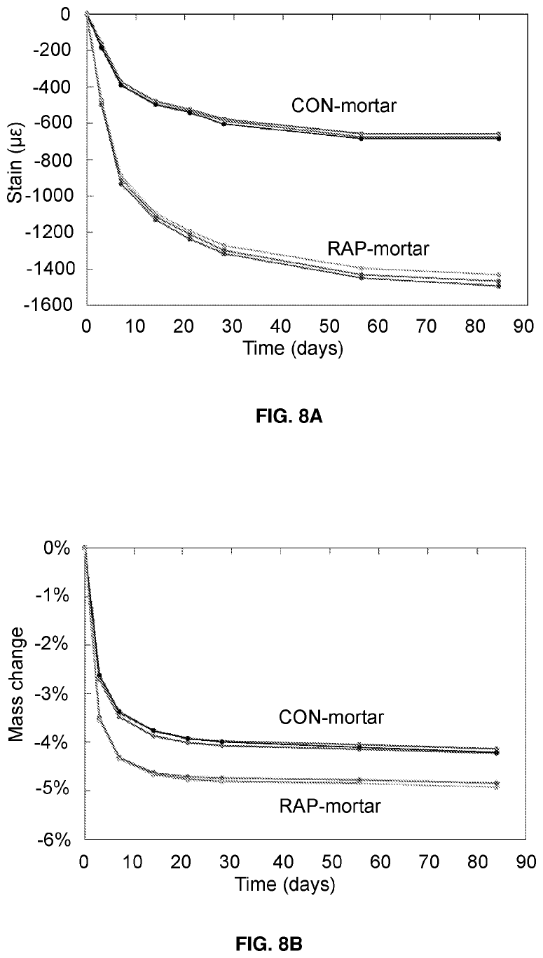

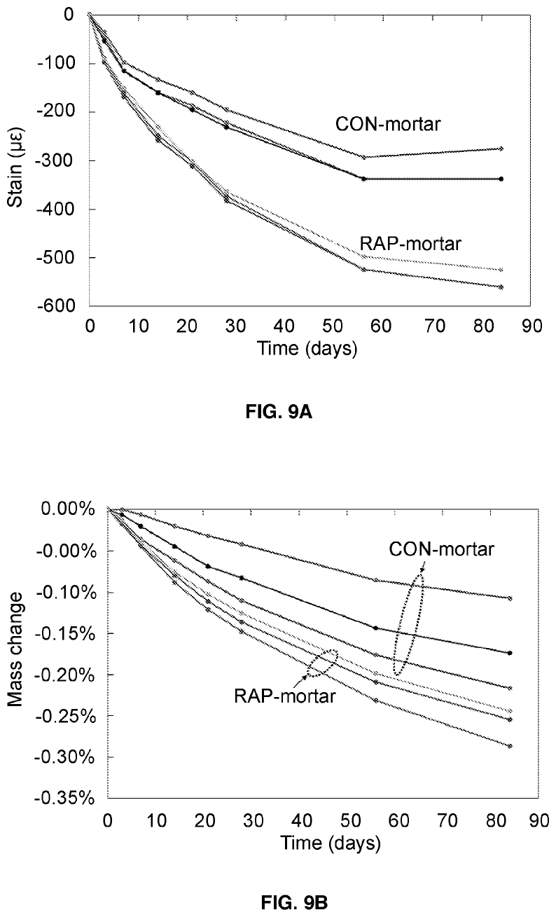

The length change and mass loss of the prism specimens subjected to the drying condition up to 84 days (12 weeks) are presented in FIGS. 8A-8B, respectively, and the results for the autogenous shrinkage test are shown in FIGS. 9A-9B. The RAP-mortar consistently has higher shrinkage and mass loss relative to the CON-mortar for both drying and autogenous cases. The average drying shrinkage for the RAP-mortar at three months is 1464 με, which is more than double that of the control mortar (673 με). For the autogenous shrinkage, this ratio is 1.7. The finding that RAP-mortar suffers higher shrinkage than the control mortar is consistent with those from previous investigations (46). The less stiff RAP aggregate yields lower restraint in the cement paste which allows the cement paste to shrink more freely.

### Restrained Drying Shrinkage

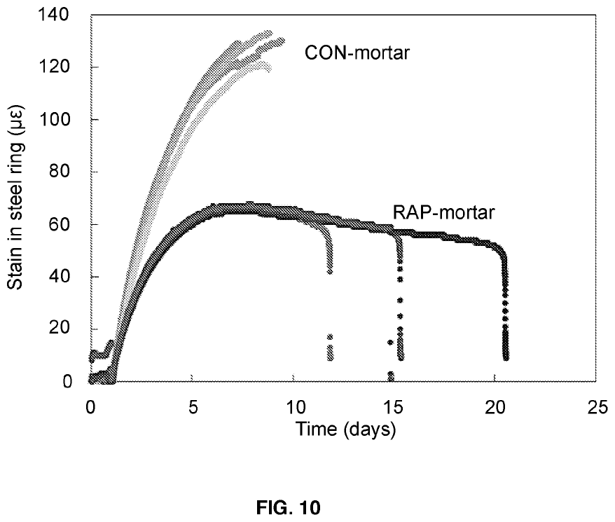

The restrained drying shrinkage results from the ring test of four CON-mortar samples and four RAP-mortar samples are shown in FIG. 10. The CON-mortar specimens rapidly developed circumferential strain in the steel until cracking. FIG. 10 only shows pre-crack strain for CON-mortar samples since the strain dropped immediately (in a single 2-minute time step) to zero after cracking. The RAP-mortar had a very different steel strain history. The slopes of the curve for the RAP-mortar in the uncracked stage and the magnitudes of the peak strain were significantly smaller. Moreover, the mortar specimens containing fine RAP showed noticeable ductile behaviors as all the specimens approximately maintained the peak strain for several days before catastrophic cracks occurred. The plateau in the curve indicates that the cracking process for the RAP-mortar was not as abrupt as the CON-mortar, suggesting multiple microcracks might have been initiated and gradually coalesced. The development of microcracks rather than the formation of a single catastrophic crack at the peak load yields significant improvements in material's toughness as creation of fracture surfaces release absorbed energy. Avoiding a single catastrophic crack also greatly improves structure safety and allows engineers to have more time to detect structure failure.

Table 3 summarizes the time of cracking for the CON-mortar specimens and the RAP-mortar specimens.

TABLE 3
Time of cracking appearance for ring test

| Mixture | Sample | | | |
|---|---|---|---|---|
| Type | Number | Time of cracking (Day) | | |
| CON-mortar | 1 | 7.33 | Ave: 8.6 | p-value for two-sample t-test |
| | 2 | 0.47 | COV: 11% | assuming unequal variance at |
| | 3 | 8.86 | | a significance level of 95% is |
| | 5 | 8.80 | | 0.033 (two-tail). This |
| RAP-mortar | 1 | 15.37 | Ave: 15.6 | suggests the difference is |
| | 2 | 11.84 | COV: 23% | statistically significant. |
| | 3 | 20.53 | | |
| | 4 | 14.93 | | |

AVE: average;
COV: coefficient of variance

Although the data for the RAP-mortar showed a slightly higher coefficient of variance, the average time of cracking for the RAP-mortar was considerably higher than that for the CON-mortar (almost twice). To verify that the difference of the cracking time between the two groups of specimens is statistically significant, a two-sample t-test assuming unequal variance was conducted. The null-hypothesis is that the mean cracking time between the RAP-mortar sample and CON-mortar sample is equal. With a significance level of 0.05, the p-value for the test is 0.03<0.05. Accordingly, the null hypothesis is rejected, meaning there is sufficient statistical evidence that the mean cracking time between the RAP mortar and CON-mortar is different. The lower Young's modulus and higher viscoelastic stress relaxation caused by the RAP addition are believed to create such difference for the ring cracking behavior between the RAP-mortar specimens and the CON-mortar specimens. With the ring testing data, the viscoelastic properties of the RAP-mortar can be extracted (47).

### EXAMPLE 5

### Materials and Mix Design: Recycled Steel Fibers (RSF)

The RSF was provided by Genan Inc. (Houston Tex.). The recycled product is a blend of loose residual rubber, thick steel wire, tire textile, and steel fiber. After the end-of-life tires are mechanically shredded into granules, the steels are subsequently extracted by an electromagnetic separator. According to Genan Inc, a 1 metric ton input of end-of-life tire could yield 150 kg of the recycled steel fiber product.

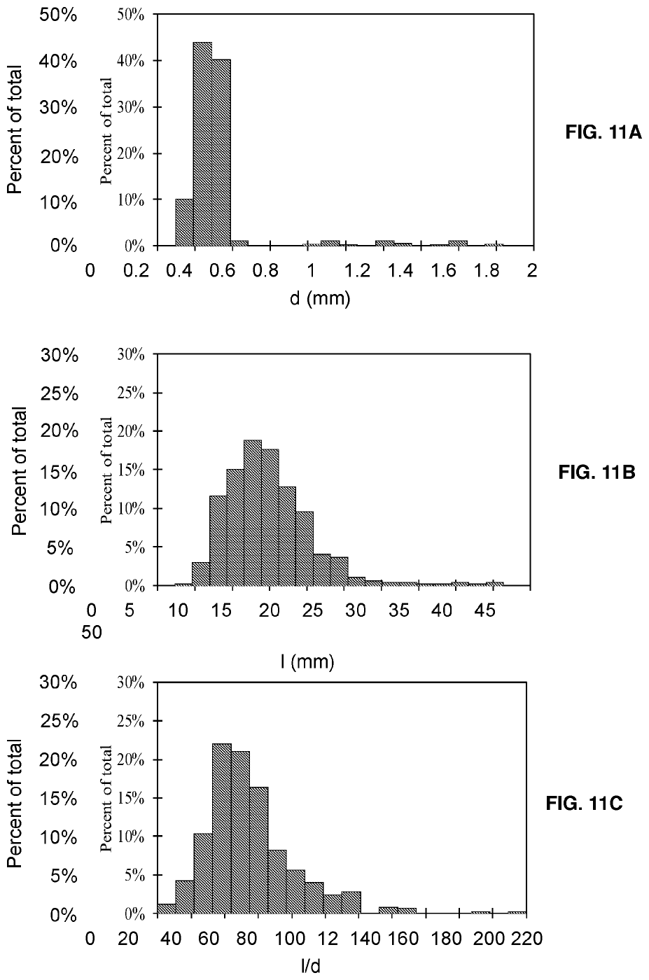

To characterize size distributions of the RSF, 500 fibers (include both the steel wire and steel fiber) were randomly selected, and their diameters and lengths were manually measured using a micrometer. FIGS. 11A-11C are histograms of fiber length, diameter, and aspect ratio (length to diameter ratio). Based on the analysis, the majority of the fiber is less than 0.5 mm and averages 0.32 mm in diameter. The fiber lengths are mostly within the range of 5-25 mm with an average value of 14.9 mm. The aspect ratio is an important parameter, which could have a direct correlation with fresh properties and hardened properties of the produced fiber reinforced concrete. The aspect ratios of the majority of the recycled steel fiber samples are within 20-70, and the average value for the characterized samples is 55.

Recycled steel fiber from scrap tires usually contains a considerable amount of residual rubber, in the form of either loose particles or residues adhered to the fiber surface. The adhered rubber may increase the roughness of the fiber surface, leading to an improved mechanical bond between the fiber and matrix (47). However, too much rubber could negatively influence cement hydration (48) and yield a weaker interfacial transition zone (49). Therefore, the residual rubber content (RRC) of the RSF is considered one of the major factors affecting the produced RSFRC properties. The RRC of the studied recycled steel fiber was tested using an ignition oven, following a similar procedure for the determination of asphalt content of asphalt mixture specified in the ASTM D6307. In the test, a 2000-gram RSF sample was first dried in an oven overnight at 60° C. to remove surface moisture. The dried recycled steel fiber sample was then conditioned in the ignition oven at a temperature of 526° C. Because this temperature is above the ignition temperature of rubber (260° C.-316° C. (50)), but is below that of steel (1100-1600° C. (50)), the rubber burned away and the steel remained intact during the ignition. The RRC of the RSF, determined using the following equation, is 2.25% in this study. It is noted that the tire textile also burned away during the ignition, but the weight of the tire textile was ignored due to its low density and small quantity compared to the rubber.

$$RRC = \frac{{M}_{A} - {M}_{B}}{{M}_{A}} ⨯ 100 \% , \qquad Eq . 2$$

where, M_{A}=total mass of the recycled steel fiber sample prior to ignition and M_{B}=total mass of recycled steel fiber remaining after ignition

Cement mortar mixtures containing 0, 1.0%, and 2.0% of the recycled steel fiber by volume were designed and produced. The selection of 1.0% and 2.0% fiber contents is based on synthesizing existing research on this topic. The cementitious material is a commercially available Type I/II cement. The fine aggregate is a concrete river sand provided by a local ready-mix concrete producer, and its maximum grain size is 4.75 mm. No supplementary cementing materials nor chemical admixtures were used in the mixtures. Other than the amount of the RSF added, all other mix design parameters were held constant based on ASTM C109 recommendations. The water to cement ratio and the sand to cement ratio were 0.40 and 2.75 by weight, respectively. The mix proportions of the studied mortar mixtures are shown in Table 4. The material specific gravities used in this mix design are cement −3.15, sand −2.58, RSF −7.85, and water −1.00

TABLE 4
Mix design—oven dry condition

| | | Cement | Sand | RSF | Water |
|---|---|---|---|---|---|
| Mix ID | Description | (kg/m³) | (kg/m³) | (kg/m³) | (kg/m³) |
| REF | Reference mixture, | 561 | 1542 | 0 | 224 |
| | without any RSF | | | | |
| 1% | RSF reinforced mortar | 555 | 1527 | 79 | 222 |
| RSFRM | (RSFRM), 1.0% RSF | | | | |
| | by volume of the total | | | | |
| | mixture | | | | |
| 2% | RSF reinforced mortar | 550 | 1511 | 157 | 220 |
| RSFRM | (RSFRM), 2.0% RSF | | | | |
| | by volume of the total | | | | |
| | mixture | | | | |

Before the mixing, the sand was oven dried at a temperature of 110±5° C. for 24 hours. The mixing procedures started by premixing the sand for two minutes at the low speed mixing mode using a HOBART mixer to break sand clumps. The RSF was then manually dispersed in the sand, followed by another two-minute mixing at the intermediate mixing speed mode. One third of the total amount of water was then added, and the blend of sand, RSF, and water was mixed for two minutes. The prepared cement batch and the rest of the water was subsequently added to the blend, and the mixture was mixed for another two minutes at the intermediate speed. The mixer was stopped and the mix was rested for three minutes. A polypropylene sheet covered the mixer to avoid water evaporation. The mixer was then switched to the high-speed mixing mode for a final two minutes.

As soon as the mixing procedures (51) were completed, flow of the fresh mortars was measured according to ASTM C1437. The flows of the REF, of the 1% RSFRM, and of the 2% RSFRM are 230, 203, and 168, respectively. The required minimum value of the flow specified by ASTM C109 is 110, so the produced mortars are considered workable. 100×200 mm cylinders were cast for the compression and splitting tension tests, and 150×300 mm cylinders were used to make SCB specimens. Additional 75×150 mm cylinder specimens were made and then cut into four 38 mm thick slices to study fiber distribution after 7 days of moist curing. For each cross section, photos were taken, and the fibers were identified and counted using an imaging process software. The total number of fibers that appeared on different cross sections was found to have a coefficient of variation that is lower than 3% for both the 1% RSFRM and 2% RSFRM. Accordingly, the fiber dispersion quality is considered good for the produced fiber reinforced cement mortars.

To study the fiber distribution, additional 75×150 mm cylinder specimens were made and then cut into four 38 mm slices after 7 days of moist curing. For each cross section, photos were taken, and the fibers were identified and counted using an imaging process software. The total number of fibers that appeared on different cross sections was found to have a coefficient of variation that is lower than 3% for both the 1% RSFRM and 2% RSFRM. Accordingly, the fiber dispersion quality is considered good for the produced fiber reinforced cement mortars.

### Compression Test

The compression test was conducted according to ASTM C469. A single experiment was used to determine both the compressive strength and Young's modulus of elasticity. 75×150 mm cylindrical specimens at 4, 7, and 28 days were uniaxial loaded by controlling the crosshead displacement of a 1000 kN-MTS machine at 1 mm/min. The displacement of the specimen was recorded by two 100-mm MTS extensometers mounted on the opposite sides of the specimen. After the load reached approximately 40% of the peak value, the test was paused, and the extensometers were carefully removed. The specimen was subsequently loaded at the same displacement rate until failure to obtain the compressive strength.

### Splitting Tension Test

The splitting tensile strength of the studied cement mortars was determined in accordance with ASTM C496. A bearing steel block was first placed on the bottom plate, and a plywood strip was centered along the lower bearing block. A 75×150 mm cylindrical specimen at the specified age (4, 7, or 28 days) was then placed on the plywood strip, and the center line of the specimen was aligned over the plywood strip. Another plywood strip was placed on top of the specimen, followed by the alignment of the upper bearing block. After the specimen setup, the splitting tension test was performed at an 18.86 kN/min loading rate using the same MTS machine from the compression test.

### Fracture Test

The newly developed SCB fracture test was used to obtain the fracture properties for the TPFM. In preparing the SCB specimens, 150x300 mm cylindrical specimens were sliced into 38 mm disks after 4, 7, and 28 days of moist curing. Each disk specimen was then cut into two SCB samples. A 3-mm wide and 36-mm long notch was made in the middle of the SCB samples; the 36 mm notch length (0.48 notch-to-radius ratio) has been verified as an effective specimen dimension for this type of test (52). It is worth noting that the radius of the SCB specimen is 75 mm, which is more than 5 times of the average fiber length and more than 30 times of the nominal maximum aggregate size of the sand used in this study. The homogeneity assumption is considered valid since RILEM has also recommended that the initial notch-to-depth ratio should be between 0.15 and 0.5 and the depth of the specimen must not be less than 3 dₐ in one of their concrete fracture property test draft standards After the SCB specimens were fabricated, two knife edges were glued to each side of the notch's bottom using epoxy.

The SCB fracture test was conducted using a stiff, high resolution MTS machine. A clip-on displacement gage was mounted to the pre-installed knife edges to record the crack mouth opening displacement (CMOD) during the test with a data recording rate of 10 Hz. The bending span-to-specimen radius ratio was 1.6. The testing procedures followed the same procedures recommended by RILEM. For each material type and curing age, at least four SCB specimens were successfully tested.

Step 1: Load the specimen monotonically up to the maximum load at the constant crosshead displacement rate of 0.05 mm/min.

Step 2: Release the load when the load passes the peak value but is still within 95% of the peak at the same displacement rate.

Step 3: When the specimen is unloaded to approximately 10% of the peak load, reload the specimen until reaching the new peak load using the same displacement rate as Step 1.

Step 4: After the second peak load, the test continues until the specimen only carries 10% of the second peak load. A faster displacement rate is used in this step to reduce the long testing time, which is caused by the high ductility of the RSFRMs.

### Ring Test: Cracking Resistance Under Restrained Shrinkage

The cracking resistance of the cement mortars under restrained drying shrinkage was assessed through a customized ring test developed by Hogancamp and Grasley (34). The size of the ring was miniaturized compared to that specified in ASTM 1609. This modified version of ring test is more effective because the cracking time of cement mortar is significantly reduced. In preparation for the ring specimen, fresh cement mortars were cast into the ring mold which consists of an inner steel ring and a removable outer ring. The outer ring was removed when the mortars became hardened after a 24-hour curing period in an environmental chamber that maintained 20±0.5° C. and 98±1% RH. The top surface of the mortar ring was sealed with adhesive aluminum foil so that drying only occurred through the radial directions. The specimens were then put back into the environment chamber, but the RH of the chamber was changed to 50±1%. During the test, the circumferential strain induced by the shrinking ring was recorded by the strain gages attached on the steel ring.

Based on the strain data, the time of specimen cracking can be accurately determined based on the identification of a sudden drop of the strain value. For each type of mixture (i.e., REF and 2% RSFRM), four ring specimens prepared from the same batch were tested.

### EXAMPLE 6

### Conventional Mechanical Properties

The conventional mechanical properties, including the compressive strength, Young's modulus of elasticity, and splitting tensile strength of the studied mixtures at 4, 7, and 28 days are shown in Table 5. The results indicate that adding the RSF only marginally improved the compressive strength and stiffness of the cement mortar. This finding agrees with the common observations reported by the existing literature on fiber reinforced cementitious materials (53). On the contrary, Table 5 shows that the RSF remarkably improved the splitting tensile strength of the cement mortar. For the 1% RSFRM, the strength improvement ranged from 8% to 24% for different ages. When 2% RSF was added, the strength improvement reached 30% to 50%. This splitting tensile strength improvement is more noticeable for the specimens with a longer curing age since curing for longer time allows the cement matrix and the RSF to develop a stronger bond. As a result, the fiber reinforcement effect is magnified.

In a comparative study on MSF reinforced cement mortar (54), 2% MSF was used with an aspect ratio of 54 to reinforce cement mortar. Note the average aspect ratio of the RSF used in this study is 55, so the fiber dimensions are similar between the two studies. In the comparative paper, the improvement in the splitting tensile strength of the cement mortar reinforced by 2% MSF was 37% when compared to its control mortar. The strength improvement of the present study by using 2% RSF is 50% is even higher than that of the 2% MSF case. The higher strength of the RSFRM is believed to be caused by the improved bonding between the RSF and cement matrix due to the high fiber surface roughness. Based on this analysis, the RSF may serve as a candidate to replace MSF as fiber reinforcement for cementitious materials.

TABLE 5
Mechanical property test results

| Mix type | 4 day | 7 day | 28 day |
|---|---|---|---|
| | Compressive strength (MPa) | | |
| REF | 29.46 (3%) | 32.45 (5%) | 36.96 (7%) |
| 1% RSFRM | 30.20 (5%) | 33.36 | 36.71 |
| 2% RSFRM | 35.62 (5%) | 39.61 (3%) | 40.78 |
| | Young’s modulus of elasticity (GPa) | | |
| REF | 28.03 (2%) | 29.73 (4%) | 31.25 (7%) |
| 1% RSFRM | 27.25 (0.3%) | 29.69 (4%) | 31.87 (7%) |
| 2% RSFRM | 30.01 (3%) | 31.26 (3%) | 33.86 (3%) |
| | Splitting tensile strength (MPa) | | |
| REF | 3.64 (2%) | 3.71 (4%) | 4.51 (14%) |
| 1% RSFRM | 3.93 (13%) ↑8% | 4.64 (10%) ↑25% | 5.60 (4%) ↑24% |
| 2% RSFRM | 4.89 (7%) ↑34% | 5.29 (5%) ↑43% | 6.79 (5%) ↑50% |

Note:
mean is reported; the coefficient of variance (CoV) is in parentheses.
↑x% = the property of the RSFRM increases by x% in comparison with the REF.

SCB test results

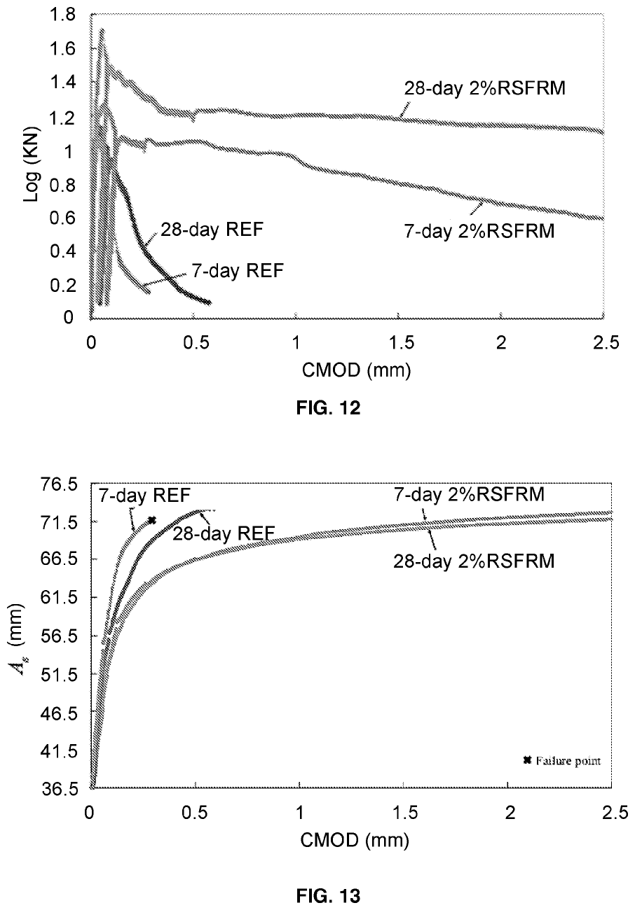

Since no mixing and consolidation problems were observed for the 2% RSFRM and the mechanical property tests showed that adding 2% RSF yielded a greater improvement in the tensile strength than the 1% RSFRM, only the 2% RSFRM was further evaluated via the SCB test. Typical load-CMOD curves for the REF and the 2% RSFRM at the specified ages are shown FIG. 12. As expected, the RSFRM exhibited a higher load capacity with more ductile post-peak behavior than the control mortar. The ultimate CMOD, which is defined as the CMOD associated with 10% of the peak load on the post-peak curve, is lower than 0.5 mm for the control mortar specimens. Within the clip gage measuring range, all the 2% RSFRM specimens still maintained a load level that is significantly higher than 10% of the peak. Therefore, the ultimate CMOD could not be measured in this study, and only data up to the CMOD of 2.5 mm is shown in FIG. 12. Using a string displacement gage or a linear variable displacement transformer could increase the CMOD measuring range [48]. Based on the results, the average residual loads at the CMOD of 2.5 mm are 0.54 MPa (CoV=21%), 0.52 MPa (CoV=22%), and 0.86 MPa (CoV=39%) for the 2% RSFRM specimens at 4, 7, and 28 days, respectively. These residual loads are equal to 46%, 41%, and 52% of the average peak loads for the 4, 7, and 28-day mixtures, respectively.

### Equivalent Crack Length

Due to high stress concentration, cracks initiate and propagate from the notch tip. The relation between the crack mouth opening displacement CMOD and the load P for the SCB geometry is expressed as:

$$CMOD = \frac{2 σ A}{E} {V}_{SCB} ( a ) \qquad Eq . 3$$

$$σ = \frac{P}{BR} \qquad Eq . 4$$

Here B and R are thickness and radius of the SCB specimen, respectively. A is the crack length. E is Young's modulus of the specimen. V_{SCB}(a) is a dimensionless coefficient. For a bending span-to-specimen radius ratio of 1.6, V_{SCB}(a) equation 5 is given by Adamson, Dempsey and Mulmule (55) based on a finite element study:

$${V}_{SCB} ( a ) = \frac{\begin{matrix}6.8772 - 19.784 a + 70.4978 {a}^{2} - 199.0382 {a}^{3} + \\ 393.6 767 {a}^{4} - 479.4072 {a}^{5} + 314.8848 {a}^{ó} - 84.5462 {a}^{7}\end{matrix}}{{( 1 - a )}^{2}}$$

a is crack length ratio:

$$a = \frac{A}{R} . \qquad Eq . 6$$

The compliance C is then written as:

$$C = \frac{CMOD}{P} = \frac{2 A}{BRE} {V}_{SCB} ( a ) . \qquad Eq . 7$$

The elastic modulus E of the specimen may be estimated using the initial secant compliance Cᵢ that determined from the linear portion of the load-CMOD curve (within 10% and 40% of the peak load) by replacing A with A₀ in Equation 7. A₀ is the initial crack length (i.e., notch length). The equivalent crack length Aₑ is then solved for by plugging Aₑ into Equation 3 based on the load-CMOD curve. The calculated crack length is termed with “equivalent” because linearity is assumed during the entire calculation despite the cementitious materials exhibiting high nonlinearity around peak load and because a pure mode I fracture (i.e., the crack propagates only in the direction of the original notch) is assumed despite the possibility that non-homogeneity at the crack tip may cause tortuous cracks.

FIG. 13 shows the typical equivalent crack lengths for the studied cement mortars at the specified ages. The 2% RSFRM specimens invariably have smaller equivalent crack lengths compared to the control mortars at the same CMOD values, which indicates that the RSF is effective at restraining cracking from propagating thanks to the fiber bridging effect. For the control specimens, the crack grows at a much faster rate and it could develop into the ultimate length even before the CMOD reaches 0.5 mm. For the 2% RSFRM specimens, the rate of crack development is much lower, and the crack would have continued to grow after the CMOD reached the upper limit of the gage's measuring range. In addition, both the control and the 2% RSFRM showed the aging-related improvement in fracture behavior; the longer the curing age, the slower the crack growth with the increase of CMOD.

Size-Independent Fracture parameter: Critical Stress Intensity Factor

The critical stress intensity factor K_{Ic}^{s} is one of the fracture parameters used in the TPFM. According to Shah, Swartz and Ouyang (56) , K_{Ic}^{s} is considered a “real” material property of cementitious materials that has no size dependency. A critical effective elastic crack length A_{c} may be defined in such a way that it results in the same secant compliance from the unloading curve Cᵤ (56). Therefore, to determine A_{c}, the secant compliances from the loading and unloading portions of the measured load-CMOD curve are set to be equal, and A_{c} can be solved for by using Equation 7. The K_{Ic}^{s} is then calculated using the critical effective elastic crack A_{c} based on LEFM:

K_{I}=σ\sqrt{πA}f_{SCB}(a) Eq.8.

Here in Equation 9 immediately below f_{SCB}(a) is another dimensionless coefficient determined by Adamson, Dempsey and Mulmule (55) .

$${f}_{SCB} ( a ) = \frac{\begin{matrix}2.653 - 8. 3354 a + 24.91 {a}^{2} - 55.2059 {a}^{3} + \\ 86.6241 {a}^{4} - 89.45 \; 06 {a}^{5} + 53.5694 {a}^{6} - 13.8676 {a}^{7}\end{matrix}}{{( 1 - a )}^{1.5}}$$

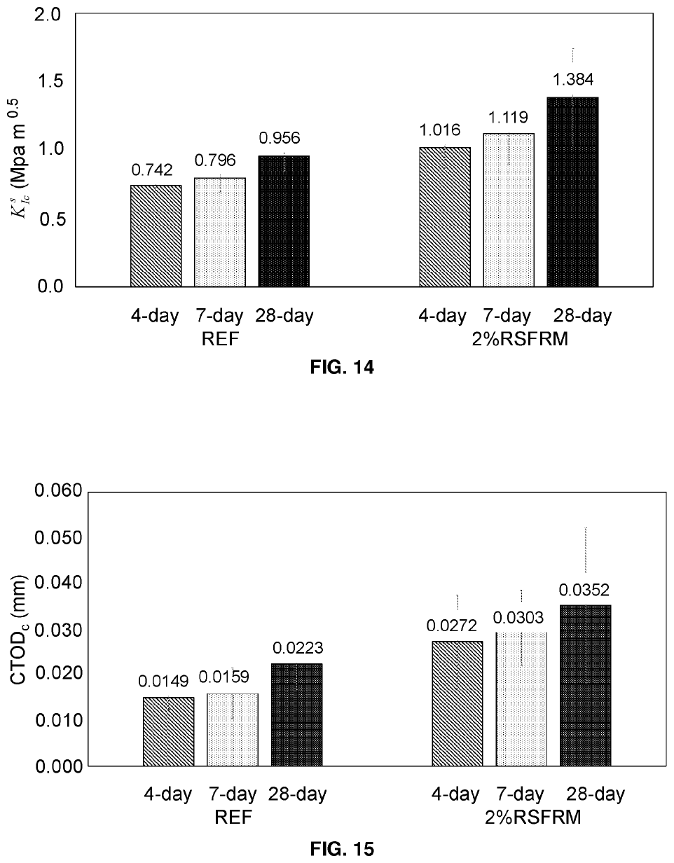

FIG. 14 compares the K_{Ic}^{s} between the control and 2% RSFRM with different ages. The 2% RSFRM specimens all have higher K_{Ic}^{s} than the control mortar specimens, irrespective of curing age. The improvements in K_{Ic}^{s} by the 2% RSF addition are 37%, 41% and 45% for 4-day, 7-day, and 28-day specimens, respectively. A statistical analysis suggested that the improvement is statistically significant at the confidence level of 95% for all the ages. Because one of the fracture criteria for the TPFM is that the stress intensity factor of a particular structure under a particular loading condition should be equal to the critical stress intensity factor, the higher K_{Ic}^{s} means that the material has a higher capacity to resist the initiation of major cracks. Therefore, the 2% RSFRM has a higher cracking resistance compared to the control mortar.

### Size-Independent Fracture Parameter: Critical Crack Tip Opening Displacement

The critical crack tip opening displacement CTOD_{c} is the other key input for the TPFM. According to the TPFM, both the stress intensity criterion and the CTOD criterion need to be satisfied at the critical fracture of the material. The CTOD is calculated as (55):

$$CTOD = \frac{2 R}{E} {\int }_{{a}_{0}}^{{a}_{e}} \frac{K ( A )}{\sqrt{R}} {h}_{r} ( s , {a}_{0} ) ds \qquad Eq . 10$$

### Note

$$\frac{K ( A )}{\sqrt{R}} = \frac{σ \sqrt{π A} {f}_{SCB} ( a )}{\sqrt{R}} = \frac{σ \sqrt{π aR} {f}_{SCB} ( a )}{\sqrt{R}} = σ \sqrt{π a} {f}_{SCB} ( a ) ,$$

so Equation Error! Reference source not found. becomes:

$$CTOD = \frac{2 P}{EB} {\int }_{{a}_{0}}^{{a}_{e}} \sqrt{π s} {f}_{SCB} ( s ) {h}_{r} ( s , {a}_{0} ) ds \qquad Eq . 11$$

hᵣ(a, y) is the weight function, whose expressions can be found in [50]. The integral part of the Equation 11, i.e.

$${\int }_{{a}_{0}}^{aj} \sqrt{π s} {f}_{SCB} ( s ) {h}_{r} ( s , {a}_{0} ) d s ,$$

is a dimensionless geometry coefficient. So, we could define:

$$l ( {a}_{e} , {a}_{0} ) = {\int }_{{a}_{0}}^{{a}_{e}} \sqrt{π s} {f}_{SCB} ( s ) {h}_{r} ( s , {a}_{0} ) ds \qquad Eq . 12$$

Then Equation Error! Reference source not found. becomes:

$$CTOD ( {a}_{e} , {a}_{0} ) = \frac{2 P}{EB} l ( {a}_{e} , {a}_{0} ) \qquad Eq . 13$$

In this study, the initial crack length ratio a₀=0.48. The l(aₑ, 0.48)values with aₑ ranging from 0.5 and 0.86 were calculated by us. l(aₑ, 0.48) was then fitted by Equation Error! Reference source not found.

$$l ( a , 0.48 ) = {\sum }_{i = 0}^{i = 7} {γ}_{i} {a}^{i} \qquad Eq . 14$$

The fitting coefficients are listed in Table 6.

TABLE 6
Fitting coefficients for l(a, 0.48)

| γ₀ | γ₁ | γ₂ | γ₃ | γ₄ | γ₅ | γ₆ | γ₇ |
|---|---|---|---|---|---|---|---|
| −1.2300 × 10⁵ | 1.3493 × 10⁶ | −6.3078 × 10⁶ | 1.6289 × 10⁷ | −2.5101 × 10⁷ | 2.3084 × 10⁷ | −1.1734 × 10⁷ | 2.5446 × 10⁶ |

By plugging A_{c} into Equation 13, the critical crack tip opening displacement CTOD_{c} was determined. The results for the studied cement mortars at different ages are shown in FIG. 15. The addition of 2% RSF was found to noticeably increase the CTOD_{c} of the cement mortar by 82%, 90%, and 58% for the 4-day, 7-day, and 28-day samples, respectively. Due to the high coefficient of variation (which has also been reported by other fracture tests (52)), the CTOD_{c} comparison between the REF and RSFRM is not statistically significant at the 95% confidence level (but it is at the 90% confidence level) for the 4-day and 28-day specimens. The improved CTOD_{c} values again reveal the 2% RSFRM's higher capacity to sustain fracturing.

### Fracture Energies

Fracture energies are material toughness indexes. In this study, two fracture energy parameters, the initial fracture energy G_{f} and the total fracture energy G_{F}, are determined as:

$${G}_{f} = \frac{{( {K}_{Ic}^{s} )}^{2}}{E} \qquad Eq . 15$$

$${G}_{F} = \frac{{{\int }^{{δ}_{f}}}_{0} Pd δ}{BU} \qquad Eq . 16$$

Here δ_{f} is the ultimate load point displacement, which is taken as 3 times the peak load displacement for both the control and the 2% RSFRM specimens. Bis the specimen thickness, and U is the initial length of the uncracked ligament.

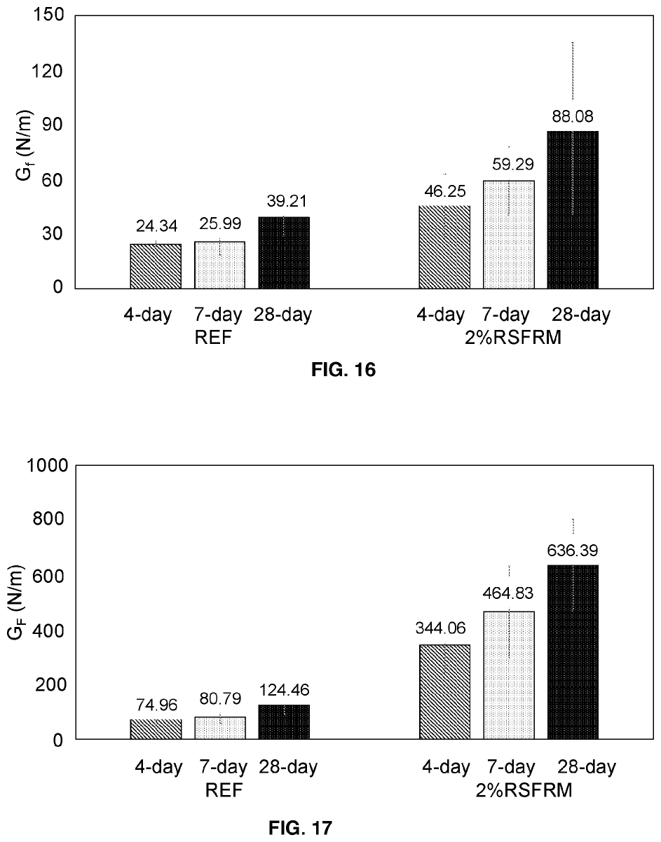

FIG. 16 and FIG. 17 show the calculated G_{f} and G_{F}, respectively. The percent increases of the G_{f} between the RSFRM and control mortar are 90%, 128%, and 125% for the 4-day, 7-day, and 28-day samples. For the G_{F}, such improvements are 359%, 475%, and 411%, respectively. It was found that all the energy term comparisons were statistically significant at the confidence level of 95%. The higher fracture energies for the RSFRM indicate the material has a higher energy absorbing capacity than the control mortar. It is noted that due to the extremely long testing time, all the fracture tests for the RSFRM specimens were terminated as soon as the CMOD reached 3mm, and G_{F} was calculated using the area under the load-displacement curve only up to three times of the peak load displacement for both the cement mortars. Therefore, the reported G_{F} values shall only be used for comparison purpose; they significantly underestimate the real G_{F} for the materials, especially for the RSFRM. It is contemplated that a faster reloading rate is necessary to capture the complete data for future FRC tests.

### Ductility

Conventionally, either a three-point bending (57) or four-point bending test (58) is used, and the post-cracking ductility is inferred through the residual flexural tensile strengths that are determined from these tests. Unfortunately, the use of residual strengths has some limitations. The residual strengths are calculated with beam equations by assuming the material is elastic with a linear stress distribution on the cross section. Furthermore, crack extension due to loading is ignored during the strength calculation. These practices clearly violate the actual specimen status during the test.

The residual stress intensity factors are used to characterize post-cracking behavior of fiber reinforced cementitious materials. The residual stress intensity factor is calculated with LEFM using the equivalent crack length. The results for both the control and 2% RSFSM at different CMOD values are compared in Table 4. Because the ultimate CMOD s are less than 0.5 mm for all the control specimens at 4 and 7 days and are only slightly higher than 0.5 mm for the 28-day specimens, only the results for CMOD values up to 0.5 mm are compared in Table 4. From Table 4, as the CMOD increases, the residual stress intensity factor increases for both mix types. The higher residual stress intensity factor indicates that further fracturing is more likely to occur (or the crack is more likely to extend). However, since cementitious materials are quasi-brittle materials, catastrophic failure immediately after the peak load is prevented because some parts of the crack surfaces may still be in contact after cracking (59). This is commonly known as the softening behavior of cementitious materials. The softening behavior of the tested RSFRM is especially noticeable, and the 2% RSF reinforced mortars with different ages all have higher residual stress intensity factors than the control mortars at the same

CMOD value. A higher residual stress intensity factor implies the material carries a higher magnitude of the stress near the tip of the equivalent crack. Therefore, it is concluded that the 2% RSFRM has a higher ability to resist fracture (or a higher fracture toughness) after the peak load. From Table 7, adding 2% RSF improved the fracture toughness of the 28-day cement mortar by as much as 76% at the CMOD of 0.5 mm.

TABLE 7
Comparison of the residual stress intensity factors for the cement mortars

| | 4 day | 7 day | 28 day |
|---|---|---|---|
| | CMOD = 0.2 mm | | |
| REF | 1.485 (5%) | 1.645 (9%) | 1.734 (8%) |
| 2% RSFRM | 1.938 (8%) ↑30% | 2.067 (10%) ↑26% | 2.165(10%) ↑25% |
| | CMOD = 0.35 mm | | |
| REF | n.a. | 2.083 (12%) | 2.140 (10%) |
| 2% RSFRM | 2.842 (9%) | 3.040 (10%) ↑46% | 3.263 (6%) ↑53% |
| | CMOD = 0.5 mm | | |
| REF | n.a. | n.a. | 2.371 (11%) |
| 2% RSFRM | 3.634 (10%) | 3.898 (9%) | 4.162 (7%) ↑76% |

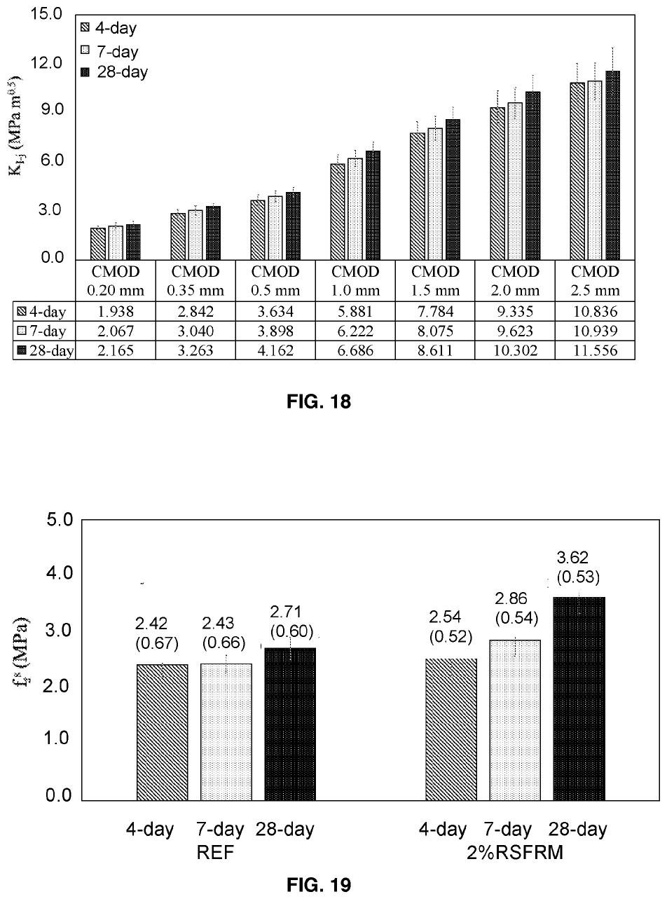

To further demonstrate the RSF's extraordinary ability to resist fracturing after the major cracking, the residual stress intensity factors for the CMOD values covering the full clip-on gage measuring range are shown in FIG. 18. At the CMOD of 2.5 mm, the residual stress intensity factor for the 28-day RSFRM is as high as 11.556 MPa\sqrt{m}. At this point, the samples suffer a very high stress intensity at the crack front but still allow stable crack propagation.

A ductility index, Dⱼ, may be defined as the ratio of the residual stress intensity factor (K_{I-j}) and the critical stress intensity factor (K_{Ic}^{s}) for fiber reinforced cementitious materials

$${D}_{j} = \frac{{K}_{I - j}}{{K}_{Ic}^{s}} , \qquad Eq . 17$$

where j indicates different CMOD levels.

The ductility indexes of the 2% RSFRM characterized in this study are shown in Table 8. With the increase of CMOD, the ductility index increases. At the same CMOD value, younger specimens invariably have higher ductility indexes than older specimens. This finding is in consistent with previous studies (56, 60-63). The ductility index can be used to screen out different mixtures. The determination of threshold values for mixture classification and the utility of the index in structural designs need future investigation though.

TABLE 8
Ductility indexes for the 2% RSFRM

| Specimen | CMOD (mm) | | | | | | |
|---|---|---|---|---|---|---|---|
| Age | 0.20 | 0.35 | 0.5 | 1.0 | 1.5 | 2.0 | 2.5 |
| 4-day | 1.91 | 2.80 | 3.58 | 5.79 | 7.66 | 9.18 | 10.66 |
| 7-day | 1.85 | 2.72 | 3.48 | 5.56 | 7.22 | 8.60 | 9.78 |
| 28-day | 1.56 | 2.36 | 3.01 | 4.83 | 6.22 | 7.44 | 8.35 |

### Theoretical Tensile Strength

Under normal lab conditions, it is almost impossible to measure the size-independent tensile strength of a quasi-brittle material since it may only be tested using an infinitely large specimen under a uniaxial direct tensile load and also because it is hard to conduct a direct tension test on cementitious material specimens due to their brittle nature. However, using the previously determined fracture properties, the size-independent theoretical tensile strength may be estimated by Equation Error! Reference source not found. Equation Error! Reference source not found. was obtained by substituting the values of K_{Ic}^{s} and CTOD_{c} into the analytical expressions for the stress intensity factor and the crack opening displacement of an infinitely-large uniaxial tensile plate with a double-edge crack [8].

$${f}_{t}^{s} = 1.4705 \frac{{( {K}_{Ic}^{s} )}^{2}}{E \cdot CTO {D}_{c}} \qquad Eq . 18$$

FIG. 19 shows the determined theoretical tensile strength for the control and 2% RSFRM at different curing ages. The results indicate that the 2% RSFRM has higher tensile strength relative to the control mortar at the same curing age. This matches the trend for the splitting tensile strength results in Table 2. In FIG. 12, the values in the parentheses are the ratios between the theoretical tensile strength and the splitting tensile strength of the same cement mortar at the same curing age. It is shown that the theoretical tensile strength is around 60% to 67% of the splitting tensile strength for the control mix, but the ratio is only 52% to 54% for the 2% RSFRM. Given the ratio values only vary within a small range for each mixture, using Equation Error! Reference source not found. to determine the theoretical tensile strength is considered valid. The difference in the strength ratios between the control and 2% RSFRM mixes is likely resulted from the varying degrees of size effect for the two different cementitious materials. The lower theoretical tensile strength to splitting tensile strength ratio for the 2% RSFRM suggests the size effect is more significant for the fiber reinforced material than for the plain cement mortar. This further infers that the 2% RSFRM has a larger fracture process zone than the plain cement mortar. Since a larger fracture process zone generally means the material is less brittle for quasit-brittle materials, the higher ductility of the RSFRM is again confirmed.

The determined theoretical tensile strength can be very useful to structural designs. If a strength-based design approach is used, the theoretical tensile strength can replace the lab-determined strengths so that the size-dependency is eliminated This will also lead to a more conservative design since the theoretical tensile strength is lowest. For a fracture-based model such as the cohesive zone model with a bilinear softening relation (64), by plugging Equation 15 and Equation 18, the kink point stress ratio, ψ, has a theoretical value of 0.265 (Equation 19) (52). This finding can eliminate the attempts to determine the kink point stress ratio from experiments.

$$ψ = 1 - \frac{{CTOD}_{c} {f}_{t}^{s}}{2 {G}_{f}} = 1 - \frac{{CTOD}_{c} \cdot 1.4705 \frac{{K}_{Ic}^{s}}{E \cdot {CTOD}_{c}}}{2 \cdot \frac{{( {K}_{Ic}^{s} )}^{2}}{E}} = 0.2 65. \qquad Eq . 19$$

The following references are cited herein.

1. Shi, et al. Journal of Cleaner Production, 225:414-425, 2019.

2. Chesner, et al. Report FHWA-RD-97-148, U.S. Dep of Transportation, Federal Highway Administration, 1998.

3. Copeland, A. Report FHWA-HRT-11-021, Turner-Fairbank Highway Research Center, Federal Highway Administration, 2011.

4. Brand, et al. Report ICT-12-008, Illinois State Toll Highway Authority, Downers Grove, Ill.

5. Debbarma, et al. “Laboratory investigation on the fresh, mechanical, and durability properties of roller compacted concrete pavement containing reclaimed asphalt pavement aggregates. Transportation Research Record: Journal of the Transportation Research Board, 2019.

6. Mukhopadhyay, A., and Shi, X. Report FHWA/TX-17/0-6855-1, U.S. Dep. of Transportation, Texas, 2017.

7. Shi, et al. Construction and Building Materials, 152:756-768, 2017.

8. Shi, et al. Journal of Cleaner Production, 192:569-581, 2018.

9. Shi, et al. International Journal of Pavement Engineering, 1-14,2018

10. Shi, et al. (2019c). Road Materials and Pavement Design, 1-23, 2019

11. Debbarma, et al. Construction and Building Materials, 199:508-525, 2019.

12. Delwar, et al. ACI Materials Journal, 94(3), 1997.

13. Huang, et al. Magazine of Concrete Research, 58(5):313-320, 2006.

14. Kumari, et al. Construction and Building Materials, 191:655-666, 2018.

15. Modarres, A. and Hosseini, Z. Materials and Design, 64:227-236, 2014.

16. Settari, et al. Construction and Building Materials, 101:617-621, 2015.

17. Singh, et al. Journal of Materials in Civil Engineering, 30(10):04018231, 2018.

18. Singh, et al. Journal of Materials in Civil Engineering, 30(10):04018233, 2018.

19. Brand, et al. Transportation Research Record: Journal of the Transportation Research Board, 2456:64-72, 2014.

20. Huang, et al. Cement and Concrete Research, 35(10):2008-2013, 2005.

21. Shi, X. “Evaluation of portland cement concrete containing reclaimed asphalt pavement for pavement applications.” PhD Dissertation, Texas A&M University, College Station, Texas, 2018.

22. U.S. Tire Manufacturers Association. U.S Scrap Tire Management Summary, 2017. ustires.org/system/files/USTMA_scraptire_summ_2017_072018.pdf.

23. Siddique, R and Naik, T. R. Waste management 24(6):563-569, 2004.

24. Shu, X. and Huang, B. Recycling of waste tire rubber in asphalt and portland cement concrete: An overview, Construction and Building Materials 67:217-224, 2014.

25. Bjegovic, et al. Journal of Civil Engineering and Management 19(sup1):S50-S60, 2013.

26. Angelakopoulos, H. and Waldron, P. “Tyre wire in concrete leading to environmental sustainability: CIP Eco-innovation project, Twincletoes project-Layman's report. Sheffield, UK: Twincon Ltd, 2015.

27. Neville, A. M. Properties of concrete, Longman London, 1995.

28. Mukhopadhyay, A., and Shi, X. ASTM STP 1613, D. Cong and D. Broton, Eds., ASTM International, West Conshohocken, Pa., 2019.

29. Abraham, S., and Ransinchung, G. Advances in Civil Engineering, DOI: 10.1520/ACEM20180161, 2019.

30. Abraham, S M., and Ransinchung, G. Construction and Building Materials, 216:202-213, 2019.

31. Berry, et al. ACI Materials Journal, 112(6), 2015.

32. Singh, S., and Ransinchung, G. (2018). Advances in Civil Engineering Materials, 7(1):271-290, 2018.

33. Tia, et al. A. Report 00088115, U.S Dep. of Transportation, Florida, 2012.

34. Hogancamp, J., and Grasley, Z. Cement and Concrete Composites, 83:405-414, 2017.

35. Thomas, J., and Jennings, H. “Overview of the hydration process.” iti.northwestern.edu/cement/monograph/monograph5_1.html, 2008.

36. Lindberg, et al. Fuel, 64(1):80-85, 1985.

37. Bralower, T., and Bice, D. “Heat capacity and energy storage.” e-education.psu.edu/earth103/node/1005, 2019

38. Wadso, L. “Isothermal calorimetry for the study of cement hydration”, Report TVBM-7166, Division of Building Materials, LTH, Lund University, 2002.

39. Du, S. Materials and Structures, 47(7):1149-1159, 2014.

40. Li, et al. Cement and Concrete Research, 28(5):635-641, 1998.

41. Tan, et al. Construction and Building Materials, 47:159-164, 2013.

42. Yang, et al. Science China Technological Sciences, 53(5):1406-1412, 2010.

43. Qiang, et al Journal of Materials in Civil Engineering, 23(9):1353-1359, 2011.

44. Brand, A. S., and Roesler, J. R. Construction and Building Materials, 130:171-181, 2017.

45. Brand, A. S., and Roesler, J. R. Construction and Building Materials, 130:182-192, 2017.

46. Topcu, I. B. and Isikdag, B. International Journal of Concrete Structures and Materials, 3(2):91-95, 2009.

47. Aiello, et al. Waste Management, 29-6:1960-1970, 2009.

48. Chou, et al. Waste Management and Research, 25(1):68-76, 2007.

49. Emiroglu, et al. An investigation on ITZ microstructure of the concrete containing waste vehicle tire. 8th International Fracture Conference, 2007. 7-8. Istanbul, Turkey.

50. Café, T. Physical constants for investigators. tcforensic.com.au/ docs/article10.html. Accessed Jul. 30, 2019.

51. Birely, et al. Fiber reinforced concrete for improved performance of transportation infrastructure. Report FHWA/AZ-18-705, U.S. Department of Transportation, Arizona, 2018.

52. Shi, et al. Composites 95:56-69, 2019.

53. Shi, et al. Construction and Building Materials 233:117316, 2020.

54. Dawood, E. T. and Ramli, M. Evolution of durable high-strength flowable mortar reinforced with hybrid fibers, ISRN Civil Engineering 2012.

55. Adamson, et al. International Journal of Fracture 77(3):213-222, 1996.

56. Østergaard, et al. Cement and Concrete Composites 26(5):563-572, 2004.

57. EN 14651: 2005+A1: 2007 Test method for metallic fibre concrete, Measuring the flexural tensile strength (limit of proportionality (LOP), residual) European Committee for Standardization, B-1050 Brussels, September 2005.

58. UNI 1039-2, Steel Fibre Reinforced Concrete-Test Method for Determination of First Crack Strength and Ductility Indexes, 2003.

59. Shah, et al, Fracture mechanics of concrete: applications of fracture mechanics to concrete, rock and other quasi-brittle materials, John Wiley & Sons, 1995.

60. Petersson, P. Cement and Concrete research 10(1):91-101, 1980.

61. Wittmann, et al. Materials and Structures 20(2):103-110, 1987.

62. Tang, et al. Materials Journal 90(5):463-471, 1993.

63. Gettu, et al. Cement and Concrete Research 28(3):349-355, 1998.

64. Park, et al. Engineering Fracture Mechanics 75(13):3806-3818, 2008.

What is claimed is:

1. A cementitious material, comprising:
a cement;
a first recycled fiber reinforcement material;
a recycled aggregate material; and
water.

2. The cementitious material of claim 1, further comprising a second recycled fiber reinforcement material.

3. The cementitious material of claim 2, wherein the second recycled fiber reinforcement material is recycled carbon fiber.

4. The cementitious material of claim 1, further comprising a virgin aggregate material.

5. The cementitious material of claim 4, further comprising a coarse aggregate material.

6. The cementitious material of claim 1, wherein the first recycled fiber reinforcement material is recycled steel fiber from scrap tires.

7. The cementitious material of claim 1, wherein the recycled aggregate material is reclaimed asphalt pavement.

8. The cementitious material of claim 1, wherein the cement comprises about 20% by volume thereof.

9. The cementitious material of claim 1, wherein the cementitious material has both an increased ductility and an increased crack resistance without loss to impact toughness, splitting tensile strength and compressive strength.

10. A crack-resistant cement concrete, comprising:
a cement;
at least one recycled fiber reinforcement material;
a recycled aggregate material;
a coarse aggregate; and
water.

11. The crack-resistant cement concrete of claim 10, further comprising a virgin aggregate material.

12. The crack-resistant cement concrete, wherein the at least one recycled fiber reinforcement material is a recycled steel fiber.

13. The crack-resistant cement concrete of claim 10, wherein the at least one recycled fiber reinforcement material comprises a recycled steel fiber and a carbon steel fiber.

14. The crack-resistant cement concrete of claim 10, wherein the recycled aggregate material is reclaimed asphalt pavement.

15. The crack-resistant cement concrete of claim 10, wherein the cement comprises about 20% by volume thereof.

16. The crack-resistant cement mortar of claim 12, wherein both crack resistance and ductility are increased without loss to impact toughness, splitting tensile strength, and compressive strength.

17. A crack-resistant cementitious mortar, comprising:
a mixture in water of a cement and of a recycled steel fiber and an aggregate of a reclaimed asphalt pavement.

13. The crack-resistant cementitious mortar of claim 17, further comprising recycled carbon fiber in the mixture.

14. The crack-resistant cementitious material of claim 17, further comprising a virgin aggregate material in the mixture.

15. The crack-resistant cementitious mortar of claim 17, wherein the reclaimed asphalt pavement is fine reclaimed asphalt pavement.

16. The crack-resistant cementitious mortar of claim 17, wherein the cement comprises about 20% by volume thereof.

17. The crack-resistant cementitious material of claim 17, wherein both crack resistance and ductility are increased without loss to impact toughness, splitting tensile strength, and compressive strength.

18. A method for increasing the crack-resistance of a cementitious material, comprising:
replacing sand in a cement mortar with a recycled aggregate material;
adding a first recycled fiber reinforcement material to the cement mortar; and
adding a volume of water.

19. The method of claim 18, further comprising adding a second recycled fiber reinforcement material to the cement mortar; and
adjusting the volume of water.

20. The method of claim 18, wherein the second recycled fiber reinforcement material is recycled carbon fiber.

21. The method of claim 18, further comprising adding a virgin aggregate material to the cement mortar; and
adjusting the volume of water.

22. The method of claim 18, wherein the first recycled fiber reinforcement material is recycled steel fiber.

23. The method of claim 18, wherein the cement comprises about 20% by volume thereof.

24. The method of claim 18, wherein the cementitious material is a cement concrete, the method further comprising:
adding a coarse aggregate; and
adjusting the volume of water.
